(19) United States
(12) Patent Application Publication
(10) Pub. No.: US 2015/0093606 A1
(43) Pub. Date: Apr. 2, 2015

(54) PUMP-FREE LITHIUM ION LIQUID FLOW BATTERY, BATTERY REACTOR AND PREPARATION METHOD OF ELECTRODE SUSPENSION SOLUTION

(71) Applicant: BEIJING HAWAGA POWER STORAGE TECHNOLOGY COMPANY LTD., Beijing (CN)

(72) Inventors: Yongchong Chen, Beijing (CN); Caimei Feng, Beijing (CN); Yanping Zhang, Beijing (CN); Ping Zhang, Beijing (CN)

(73) Assignee: BEIJING HAWAGA POWER STORAGE TECHNOLOGY COMPANY LTD., Beijing (CN)

(21) Appl. No.: 14/399,863

(22) PCT Filed: Apr. 26, 2013
(86) PCT No.: PCT/CN2013/074801

§ 371 Date: Nov. 7, 2014

(30) Foreign Application Priority Data
May 10, 2012 (CN) 201210144560.5
Nov. 7, 2012 (CN) 201210440281.3

(51) Int. Cl. H01M 10/42; H01M 10/0525; H01M 8/20; H01M 10/48; H01M 8/18

(52) U.S. Cl. CPC H01M 10/4214; H01M 10/48; H01M 8/188; H01M 8/20; H01M 10/0525
USPC 429/50; 429/72; 429/61; 429/105

(57) ABSTRACT

A Pump-free lithium ion liquid flow battery, battery reactor and preparation method of electrode suspension solution. The Pump-free lithium ion liquid flow battery includes a positive electrode liquid preparation tank (27), a negative electrode liquid preparation tank (32), a positive electrode liquid collection tank (30), a negative electrode liquid collection tank (35), a positive electrode conveying tank (31), a negative electrode conveying tank (36) and several battery sub-systems. The positive electrode conveying tank (31) intermittently moves vertically to and fro for the transportation of positive electrode suspension solution between the positive electrode liquid collection tank (30) and the positive electrode liquid preparation tank (27). The negative electrode conveying tank (36) intermittently moves vertically to and fro for the transportation of negative electrode suspension solution between the negative electrode liquid collection tank (35) and the negative electrode liquid preparation tank (32). The circuit combination of several battery sub-systems is in series connection. The Pump-free lithium ion liquid flow battery provided in the present invention can reduce mechanical losses and security risks, improve battery working efficiency and ensure better safety performance.

### CROSS-REFERENCE TO RELATED APPLICATION

This application claims the benefits of CN Application No. 201210144560.5 filed on May 10, 2012, titled “PUMP-FREE LITHIUM ION FLOW BATTERY AND PREPARATION METHOD OF ELECTRODE SUSPENSION SOLUTION THEREOF” and CN Application No. 201210440281.3 filed on Nov. 7, 2012, titled “LITHIUM ION FLOW BATTERY REACTOR”, which are incorporated herein by reference in their entirety.

### FIELD OF THE INVENTION

The present invention relates to the field of chemical energy storage technologies, and in particular, to a pump-free lithium ion flow battery, a battery reactor and a preparation method of an electrode suspension solution.

### BACKGROUND OF THE INVENTION

The wide application of electric energy is regarded as one of the greatest achievements of human in the 20^{th} century. The electric power industry becomes one of the most important basic industries of a state. The modern electric power system is developing toward the direction of power pool and large machine set, and the novel energy resource electric grid is also developing to a new stage. Low-cost and extensible energy resource storage is the key point to improve the electric grid efficiency and develop reproducible energy resource technologies (for example, wind energy and solar energy). Due to its advantages of high energy density, simpleness and reliability, etc., electrochemical energy storage stands in an important position in electric energy application.

Lithium ion flow battery is a novel energy storage battery, it combines the respective advantages of a lithium ion battery and a fluid flow battery, and it belongs to a long-lifetime and environment-friendly novel chemical energy storage technology in which the energy storage capacity and the power are independent from each other. The current lithium ion flow battery is consisted of the positive electrode liquid stock tanks, the negative electrode liquid stock tanks, the battery reactors, the liquid pumps and the sealed tubes. Wherein, a mixture of positive electrode composite particles (for example, lithium iron phosphate composite particles) and an electrolyte is loaded in the positive electrode liquid stock tank, and a mixture of negative electrode composite particles (for example, lithium titanate composite particles) and an electrolyte is loaded in the negative electrode liquid stock tank. Referring to FIG. 1, during the operation of a prior-art lithium ion flow battery, the electrode suspension solution flows between the liquid stock tank and the battery reactor via the sealed tube under the propulsion of a liquid pump 4, and the flow rate may be adjusted according to the concentration of the electrode suspension solution and the ambient temperature. Wherein, the positive electrode suspension solution enters an positive electrode reacting chamber 1 of the battery reactor via an positive electrode liquid feed port, and returns to the positive electrode liquid stock tank from an positive electrode liquid discharge port via the sealed tube after reaction. At the same time, the negative electrode suspension solution enters a negative electrode reacting chamber 2 of the battery reactor via a negative electrode liquid feed port, and returns to the negative electrode liquid stock tank from a negative electrode liquid discharge port via the sealed tube after reaction. An electron-nonconductive porous separater 3 exists between the positive electrode reacting chamber 1 and the negative electrode reacting chamber 2, and it isolates the positive electrode active material particles in the positive electrode suspension solution and the negative electrode active material particles in the negative electrode suspension solution from each other, so that short-circuiting inside the battery due to the direct contact of the positive electrode and negative electrode active material particles may be avoided. Lithium ion exchange and transmission may be performed between the positive electrode suspension solution in the positive electrode reacting chamber 1 and the negative electrode suspension solution in the negative electrode reacting chamber 2 via the electrolyte in the porous separater 3.

Although the lithium ion flow battery has many advantages in large-scale energy storage applications, however, because the electrode suspension solution has a large viscosity, a great mechanical loss will be generated when a liquid pump 4 is employed for the circulation of the electrode suspension solution, thus the energy efficiency of the battery will be badly deteriorated. The liquid pump also tends to cause the leakage of the electrode suspension solution or cause it to contact the aqueous vapour and oxygen gas in the atmosphere, thereby potential danger may be caused. Additionally, because the electrode suspension solution in the lithium ion flow battery has electron conductivity, there exists no integral battery series-parallel system currently, and it becomes an urgent problem to be solved currently how to design a large-capacity high-voltage lithium ion flow battery.

In addition, the critical component of the lithium ion flow battery is the battery reactor. The existing lithium ion flow battery reactor is consisted of an electrode box with a crossed structure, the manufacture process is simple, and short circuiting inside the battery can be avoided by the double-separater structure employed, so that the safety performance of the battery can be improved greatly; at the same time, because the gap between the positive electrode and the negative electrode is small and the structure is compact, the charging and discharging performance of the battery may be improved greatly. However, the disadvantages lie in that, the flowability of the electrode suspension solution on the flat current collecting plate is poor and nonuniform; at the same time, because the electrode suspension solution is consisted of an organic electrolyte, an electrode active material and a conductive additive, it is a nonaqueous suspension solution, and because no gas protection device or gas channel is set, the safety performance of the current battery reactor is poor, and the thermal diffusivity is bad, which influences the overall performance and the batch implementation of the lithium ion flow battery to a certain degree.

### SUMMARY OF THE INVENTION

The embodiments of the invention provide a pump-free lithium ion flow battery, a battery reactor and a preparation method of an electrode suspension solution, for solving the problems of the low energy efficiency of the existing lithium ion flow battery, easily occurred mechanical loss and hidden safety risk of the battery, and the deteriorated functional performance of the battery.

In order to solve the above technical problems, the following technical solutions are disclosed in the embodiments of the invention:

In the first aspect, there provides a pump-free lithium ion flow battery, which includes: an positive electrode liquid preparation tank, a negative electrode liquid preparation tank, an positive electrode liquid collection tank, a negative electrode liquid collection tank, an positive electrode transportation tank, a negative electrode transportation tank and several battery subsystems; wherein:

the positive electrode liquid preparation tank and the negative electrode liquid preparation tank are located above said several battery subsystems, a liquid discharge port of the positive electrode liquid preparation tank is connected with an positive electrode liquid feed port of the battery subsystem via a tube, and an positive electrode liquid distribution valve is set on the tube; the liquid discharge port of the negative electrode liquid preparation tank is connected with the negative electrode liquid feed port of the battery subsystem via a tube, and a negative electrode liquid distribution valve is set on the tube, the positive electrode liquid collection tank and the negative electrode liquid collection tank are located below said several battery subsystems, and a liquid feed port of the positive electrode liquid collection tank is connected with an positive electrode liquid discharge port of the battery subsystem via a tube, and an positive electrode liquid collecting valve is set on the tube; a liquid feed port of the negative electrode liquid collection tank and a negative electrode liquid discharge port of the battery subsystem are connected via a tube, and a negative electrode liquid collecting valve is set on the tube.

the circuit combination mode between said several battery subsystems is a series connection mode, and the battery subsystem includes: an positive electrode liquid feed tank, a negative electrode liquid feed tank, an positive electrode liquid discharge tank, a negative electrode liquid discharge tank and an positive electrode liquid feed port, an positive electrode liquid discharge port, a negative electrode liquid feed port, a negative electrode liquid discharge port and several battery reactors;

the battery reactor includes an positive electrode reacting chamber and a negative electrode reacting chamber, and the positive electrode liquid feed tank and the negative electrode liquid feed tank are located above the battery reactor; the liquid feed port of the positive electrode liquid feed tank is the positive electrode liquid feed port of the battery subsystem, the liquid discharge port of the positive electrode liquid feed tank is connected with the positive electrode reacting chamber of the battery reactor via a tube, and an positive electrode liquid feed valve is set therebetween; the liquid feed port of the negative electrode liquid feed tank is the negative electrode liquid feed port of the battery subsystem, the liquid discharge port of the negative electrode liquid feed tank is connected with the negative electrode reacting chamber of the battery reactor via a tube, and a negative electrode liquid feed valve is set therebetween, and the positive electrode liquid discharge tank and the negative electrode liquid discharge tank are located below the battery reactor; the liquid feed port of the positive electrode liquid discharge tank is connected with the positive electrode reacting chamber of the battery reactor via a tube, and an positive electrode liquid discharge valve is set therebetween, and the liquid discharge port of the positive electrode liquid discharge tank is the positive electrode liquid discharge port of the battery subsystem; the liquid feed port of the negative electrode liquid discharge tank is connected with the negative electrode reacting chamber of the battery reactor via a tube, and a negative electrode liquid discharge valve is set therebetween, and the liquid discharge port of the negative electrode liquid discharge tank is the negative electrode liquid discharge port of the battery subsystem; and

during the operation of the lithium ion flow battery, at most one of the battery subsystems is in communication with the positive electrode liquid preparation tank, the positive electrode liquid collection tank, the negative electrode liquid preparation tank or the negative electrode liquid collection tank.

The circuit combination mode between the battery reactors inside the battery subsystem is parallel connection mode.

The parallel arrangement mode of the battery reactors includes: transversal arrangement from left to right, or longitudinal arrangement from top to bottom, or an array consisted of a plurality of transversal arrangements and a plurality of longitudinal arrangements.

The positive electrode liquid preparation tank, the negative electrode liquid preparation tank, the positive electrode liquid collection tank, the negative electrode liquid collection tank, the positive electrode transportation tank and the negative electrode transportation tank, and the positive electrode liquid feed tank, the negative electrode liquid feed tank, the positive electrode liquid discharge tank and the negative electrode liquid discharge tank all include one or more liquid feed ports located on the bottom surface of the tank of the pump-free lithium ion flow battery and one or more liquid discharge ports located on the lateral surface of the tank, an inert gas inlet and an inert gas outlet are set on the top of the tank, the inlet is connected with a gas storage system, and the outlet is connected with a gas collection system; a pressure stabilizer is set at the inlet, a pressure limiter is set at the outlet, the gas pressure in the tank is adjusted by the pressure stabilizer and the pressure limiter and is kept constant, and the inert gas recycled by the gas collection system enters the gas storage system for cyclic utilization after purification and pressurization.

An positive electrode suspension solution and an inert gas are loaded in the positive electrode liquid feed tank and the positive electrode liquid discharge tank, and a negative electrode suspension solution and an inert gas are loaded in the negative electrode liquid feed tank and the negative electrode liquid discharge tank;

A soft gas bag is set fixedly on the top inside of the tank, the soft gas bag is connected with the inlet and the outlet, and the soft gas bag is configured for pressurizing the positive electrode suspension solution or the negative electrode suspension solution by controlling the inert gas filled in so as to discharge the positive electrode suspension solution or the negative electrode suspension solution from the liquid discharge port.

During the operation of the pump-free lithium ion flow battery, the gas pressure in the positive electrode liquid feed tank is kept consistent with the gas pressure in the negative electrode liquid feed tank, and the gas pressure in the positive electrode liquid discharge tank is kept consistent with the gas pressure in the negative electrode liquid discharge tank.

One or more positive electrode liquid preparation transition tanks are added between the positive electrode liquid preparation tank and the positive electrode liquid feed tank; one or more negative electrode liquid preparation transition tanks are added between the negative electrode liquid preparation tank and the negative electrode liquid feed tank; one or more positive electrode liquid collection transition tanks are added between the positive electrode liquid discharge tank and the positive electrode liquid collection tank; and one or more negative electrode liquid collection transition tanks are added between the negative electrode liquid discharge tank and the negative electrode liquid collection tank.

The fluid flow battery further includes a safeguard system, which includes: a battery monitoring subsystem and a suspension solution displacing device;

the battery monitoring subsystem is configured for monitoring each index of the pump-free lithium ion flow battery and starting the suspension solution displacing device when abnormality occurs on the pump-free lithium ion flow battery; and

the suspension solution displacing device is configured for separating the positive electrode suspension solution and the negative electrode suspension solution during the starting.

The battery monitoring subsystem includes: a signal collection device, a microprocessor, a display instrument and an alarming and prompting device; wherein, the signal collection device, the display instrument and the alarming and prompting device are respectively connected with the microprocessor; and the signal collection device includes a current sensor, a voltage sensor, a temperature sensor and a gas composition analysis sensor;

the current sensor and the voltage sensor are connected with the positive electrode and the negative electrode of the battery reactor, for respectively testing the current and voltage during the charging and discharging of the battery reactor;

the temperature sensor and the gas composition analysis sensor are set in an inert gas channel of the battery reactor, for respectively monitoring the real-time temperature and gas composition change of the battery reactor;

the microprocessor is configured for analyzing the current, voltage, temperature and gas composition collected by the signal collection system and starting the suspension solution displacing device when the analysis result is abnormal;

the alarming and prompting device is configured for alarming when the analysis result is abnormal; and

the data display instrument is configured for displaying the analysis result.

The suspension solution displacing device includes: an inert gas pressure control unit, a sealed tube, a suspension solution control valve and a gas pressure control valve, wherein the inert gas pressure control unit is respectively connected with the positive electrode reacting chamber and the negative electrode reacting chamber of the battery reactor via a sealed tube and a control valve;

when the suspension solution displacing device is started, the positive electrode suspension solution is made to flow into an positive electrode suspension solution recycle tank and the negative electrode suspension solution is made to flow into a negative electrode suspension solution recycle tank by controlling the opening or closing of the suspension solution control valve and the gas pressure control valve.

The suspension solution displacing device includes: an positive electrode inert liquid storage tank, an positive electrode inert liquid recycle tank, a negative electrode inert liquid storage tank, a negative electrode inert liquid recycle tank, an inert gas pressure control unit, a sealed tube and several control valves; wherein the positive electrode inert liquid storage tank, the positive electrode inert liquid recycle tank, the negative electrode inert liquid storage tank, the negative electrode inert liquid recycle tank, the inert gas pressure control unit, the sealed tube and the several control valves are respectively connected with the positive electrode reacting chamber and the negative electrode reacting chamber of the battery reactor;

when the suspension solution displacing device is started, by controlling the opening or closing of the suspension solution control valve and the gas pressure control valve, the positive electrode inert liquid is fed into the positive electrode reacting chamber of the battery reactor and mixed with the positive electrode suspension solution and then flows into the positive electrode inert liquid recycle tank, and the negative electrode inert liquid is fed into the negative electrode reacting chamber of the battery reactor and mixed with the negative electrode suspension solution and then flows into the negative electrode inert liquid recycle tank.

The valve body is an internal insulation valve, and when the internal insulation valve is opened, the electrode suspension solutions on the two sides of the valve body will be in communication with each other; when the internal insulation valve is closed, the electrode suspension solutions on the two sides of the valve body will be disconnected.

In the second aspect, there provides a pump-free lithium ion flow battery reactor, wherein the battery reactor is a battery reactor that applied to the pump-free lithium ion flow battery, and the battery reactor includes: a porous separater, an positive electrode current collecting plate and a negative electrode current collecting plate; wherein the positive electrode current collecting plate, the porous separater and the negative electrode current collecting plate are stacked together to form a stacked structure;

Wherein, the positive electrode current collecting plate and the negative electrode current collecting plate are corrugated plates with through grooves, and the direction of the through grooves of the positive electrode current collecting plate and the direction of the through grooves of the negative electrode current collecting plate are perpendicular to each other; an positive electrode current collecting plate is set between the two porous separaters to form an positive electrode reacting chamber, and a negative electrode current collecting plate is set between the two porous separaters to form a negative electrode reacting chamber; the porous separaters are bound and fixed to the positive electrode current collecting plate and the negative electrode current collecting plate along the groove direction on the two sides of the current collecting plates, and the adjacent positive electrode reacting chamber and negative electrode reacting chamber are bound and fixed around the edge; the positive electrode suspension solution circulates in the positive electrode reacting chamber along the groove direction, and the negative electrode suspension solution circulates in the negative electrode reacting chamber along the groove direction; the lateral surfaces on the two ends of the circulation direction of the positive electrode suspension solution are respectively side A and side A′, and the lateral surfaces on the two ends of the circulation direction of the negative electrode suspension solution are respectively side B and side B′, wherein, the side A and the side A′ are respectively perpendicular to the side B the side B′.

The sectional waveforms of the positive electrode current collecting plate and the negative electrode current collecting plate include: sine wave, square wave, triangular wave, trapezoidal wave, sawtooth wave, impulse wave, or convex-concaved abnormity wave.

An aluminum plate or an aluminum-coated metal plate is employed as the material of the positive electrode current collecting plate, and the thickness is in the range of 0.05 to 0.5 mm; a copper plate, a nickel plate, a copper-coated metal plate or a nickel-coated metal plate is employed as the material of the negative electrode current collecting plate, and the thickness is in the range of 0.05 to 0.5 mm.

An insulating layer is coated on the outside of the convex points or the concave points of the positive electrode current collecting plate or the negative electrode current collecting plate; and the thickness of the insulating layer is less than 0.1 mm.

An positive electrode tab is respectively set on the side A and the side A′ of the positive electrode current collecting plate, and the positive electrode current collecting plate of each layer is respectively connected by an positive electrode pole via the positive electrode tab; a negative electrode tab is respectively set on the side B and the side B′ of the negative electrode current collecting plate, and the negative electrode current collecting plate of each layer is respectively connected by a negative electrode pole via the negative electrode tab; the positive electrode pole and the negative electrode pole are respectively conductive metal rods.

The battery reactor further includes: two cooling plates, wherein a gas channel is set on the surface of the cooling plate, a structure stacked by the porous separater and the positive electrode current collecting plate and the negative electrode current collecting plate is located between the two cooling plates to form a battery module, and n battery modules are stacked together to form a battery stack, wherein n is a natural number greater than 1.

A feeding diversion chamber and a discharging diversion chamber are respectively set on the upside and the underside of the battery stack, and an positive electrode diversion chamber and a negative electrode diversion chamber that are not in communication with each other are set respectively inside the feeding diversion chamber and the discharging diversion chamber, and the feeding diversion chamber is provided with an positive electrode liquid feed port and a negative electrode liquid feed port, and one end of the positive electrode diversion chamber and the negative electrode diversion chamber is respectively connected with the positive electrode liquid feed port and the negative electrode liquid feed port, and the other end respectively leads to two perpendicular lateral surfaces of the feeding diversion chamber, and the two lateral surfaces are the side A and the side B; and the discharging diversion chamber is provided with an positive electrode liquid discharge port and a negative electrode liquid discharge port, and one end of the positive electrode diversion chamber and the negative electrode diversion chamber is respectively connected with the positive electrode liquid discharge port and the negative electrode liquid discharge port, and the other end respectively leads to two perpendicular lateral surfaces of the discharging diversion chamber, and the two lateral surfaces are respectively the side A and the side B or the side A′ and the side B′.

Steering caps are set on the same lateral surface of the feeding diversion chamber and the first layer of battery module, adjacent two layers of battery modules, and the n^{th} layer of battery module and the discharging diversion chamber;

If n is an even number, n/2+1 steering caps are set on the side A of the feeding diversion chamber and the first layer of battery module, the second and the third layers of battery modules, the (n−2)^{th} and the (n−1)^{th} layers of battery modules, and the n^{th} layer of battery module and the discharging diversion chamber, and n/2 steering caps are set on the side A′ of the first and the second layers of battery modules and the (n−1)^{th} and the n^{th} layers of battery modules; moreover, n/2+1 steering caps are set on the side B of the feeding diversion chamber and the first layer of battery module, the second and the third layers of battery modules, the (n−2)^{th} and the (n−1)^{th} layers of battery modules, and the n^{th} layer of battery module and the discharging diversion chamber, and n/2 steering caps are set on the side B′ of the first and the second layers of battery modules, the second and the third layers of battery modules and the (n−1)^{th} and the n^{th} layers of battery modules;

if n is an odd number, (n+1)/2 steering caps are respectively set on the side A of the feeding diversion chamber and the first layer of battery module, the second and the third layers of battery modules, and the (n−1)^{th} and the n^{th} layers of battery modules, and (n+1)/2 steering caps are set on the side A′ of the first and the second layers of battery modules, the second and the third layers of battery modules, the (n−2)^{th} and the (n−1)^{th} layers of battery modules, and the n^{th} layer of battery module and the discharging diversion chamber; moreover, (n+1)/2 steering caps are respectively set on the side B of the feeding diversion chamber and the first layer of battery module, the second and the third layers of battery modules, the (n−1)^{th} and the n^{th} layers of battery modules, and (n+1)/2 steering caps are set on the side B′ of the first and the second layers of battery modules, the second and the third layers of battery modules, the (n−2)^{th} and the (n−1)^{th} layers of battery modules, and the n^{th} layer of battery module and the discharging diversion chamber.

The positive electrode diversion chamber and the negative electrode diversion chamber of the feeding diversion chamber and the discharging diversion chamber are dendriform, which include a main channel and more than two subchannels branched from the main channel; the positive electrode liquid feed port and the negative electrode liquid feed port are respectively connected with the main channels of the positive electrode diversion chamber and the negative electrode diversion chamber of the feeding diversion chamber; the positive electrode liquid discharge port and the negative electrode liquid discharge port are respectively connected with the main channel of the positive electrode diversion chamber and the negative electrode diversion chamber of the discharging diversion chamber.

The battery reactor further includes a gas protection chamber;

Wherein, the feeding diversion chamber, the battery stack, the steering cap and the discharging diversion chamber are placed inside the gas protection chamber, and a gas inlet, a gas outlet, an positive electrode pole hole, an positive electrode liquid inlet and a negative electrode liquid inlet are opened on the top of the gas protection chamber, and the positive electrode liquid inlet and the negative electrode liquid inlet are respectively connected with the positive electrode liquid feed port and the negative electrode liquid feed port, and the positive electrode pole is connected by a wire and led out from the positive electrode pole hole to form an positive electrode; a negative electrode pole hole, and an positive electrode liquid outlet and a negative electrode liquid outlet are opened on the bottom of the gas protection chamber, and the positive electrode liquid outlet and the negative electrode liquid outlet are respectively connected with the positive electrode liquid discharge port and the negative electrode liquid discharge port, and all the negative electrode poles are connected with another wire and led out from the negative electrode pole whole to form a negative electrode main pole.

In the third aspect, there provides a preparation method of an electrode suspension solution for a pump-free lithium ion flow battery, wherein the method is used to prepare the electrode suspension solution in the above pump-free lithium ion flow battery, and the preparation method includes:

feeding in an electrode suspension solution: when the electrode suspension solution is an positive electrode suspension solution, the positive electrode liquid feed valve is closed, and the positive electrode liquid distribution valve is opened, the gas pressure in the positive electrode liquid preparation tank and the positive electrode liquid discharge tank is stabilized at a constant value in the range of 1 to 2 atmospheric pressures via a pressure stabilizer and a pressure limiter, and the values of the gas pressure in the positive electrode liquid preparation tank and the positive electrode liquid discharge tank are the same; an positive electrode transportation tank loaded with an positive electrode suspension solution is lifted to above the positive electrode liquid preparation tank, and the gas pressure in the positive electrode transportation tank is adjusted via a pressure stabilizer and a pressure limiter to make the gas pressure in the positive electrode transportation tank higher than the gas pressure in the positive electrode liquid preparation tank by 0 to 0.5 atmospheric pressure, and the gas pressure is kept constant; the positive electrode transportation tank and the positive electrode liquid preparation tank are connected via a sealed tube, so that the positive electrode suspension solution in the positive electrode transportation tank flows into the positive electrode liquid preparation tank and the positive electrode liquid feed tank in turn under the action of gas pressure and gravity; when the content of the positive electrode suspension solution in the positive electrode liquid feed tank reaches the capacity upper limit of the tank, the positive electrode liquid distribution valve is closed, and when the content of the positive electrode suspension solution in the positive electrode liquid preparation tank reaches the capacity upper limit of the tank, the connection between the positive electrode transportation tank and the positive electrode liquid preparation tank is disconnected, and system feeding is accomplished; when the electrode suspension solution is a negative electrode suspension solution, the feeding mode of the negative electrode suspension solution is consistent with that of the positive electrode suspension solution, and the values of the gas pressure in the positive electrode liquid feed tank and the negative electrode liquid feed tank are constant and the same.

the electrode suspension solution entering the battery reactor and participating in the battery reaction: the gas pressure in the positive electrode liquid discharge tank and the gas pressure in the negative electrode liquid discharge tank are adjusted via a pressure stabilizer and a pressure limiter to make the gas pressure in the positive electrode liquid discharge tank the same as the gas pressure in the negative electrode liquid discharge tank and lower than the gas pressure in the positive electrode liquid feed tank and the negative electrode liquid feed tank by 0 to 0.5 atmospheric pressure, and the gas pressure is kept constant; at the same time, the positive electrode liquid feed valve, the negative electrode liquid feed valve, the positive electrode liquid discharge valve and the negative electrode liquid discharge valve are opened to make the positive electrode suspension solution and the negative electrode suspension solution respectively flow into the positive electrode reacting chamber and the negative electrode reacting chamber under the action of gravity and gas pressure, and respectively flow into the positive electrode liquid discharge tank and the negative electrode liquid discharge tank after participating in the battery reaction, and during the flowing in process, the positive electrode suspension solution and the negative electrode suspension solution are controlled to enter the battery reactor simultaneously;

collecting the electrode suspension solution after the battery reaction: during the collecting of the positive electrode suspension solution, when the content of the positive electrode suspension solution in the positive electrode liquid discharge tank reaches the capacity upper limit, the gas pressure in the positive electrode liquid collection tank is adjusted via a pressure stabilizer and a pressure limiter to make the gas pressure in the positive electrode liquid collection tank lower than the gas pressure in the positive electrode liquid discharge tank by 0 to 0.5 atmospheric pressure, and the gas pressure is kept constant, and the positive electrode liquid discharge valve is opened to make the positive electrode suspension solution in the positive electrode liquid discharge tank flow into the positive electrode liquid collection tank under the action of gravity and gas pressure, and when the content of the positive electrode suspension solution in the positive electrode liquid discharge tank reaches the capacity lower limit of the tank or when the content of the positive electrode suspension solution in the positive electrode liquid collection tank reaches the capacity upper limit of the tank, the gas pressure in the positive electrode liquid collection tank is adjusted to be consistent with the gas pressure in the positive electrode liquid discharge tank via a pressure stabilizer and a pressure limiter, and the positive electrode liquid collecting valve is closed; during the collecting of the negative electrode suspension solution, the collecting process of the negative electrode suspension solution is consistent with the collecting process of the positive electrode suspension solution.

The method further includes: preparing an positive electrode suspension solution into the positive electrode liquid feed tank when the content of the positive electrode suspension solution in the positive electrode liquid feed tank reaches the capacity lower limit; preparing a negative electrode suspension solution into the negative electrode liquid feed tank when the content of the negative electrode suspension solution in the negative electrode liquid feed tank reaches the capacity lower limit;

The preparation process of the positive electrode suspension solution includes: adjusting the gas pressure in the positive electrode liquid preparation tank via a pressure stabilizer and a pressure limiter to make the gas pressure in the positive electrode liquid preparation tank higher than the gas pressure in the positive electrode liquid feed tank by 0 to 0.5 atmospheric pressure, and keeping the gas pressure constant; opening the positive electrode liquid distribution valve to make the positive electrode suspension solution in the positive electrode liquid preparation tank flow into the positive electrode liquid feed tank under the action of gravity and gas pressure, and adjusting the gas pressure in the positive electrode liquid preparation tank to be consistent with the gas pressure in the positive electrode liquid feed tank via a pressure stabilizer and a pressure limiter when the volume of the positive electrode suspension solution in the positive electrode liquid feed tank reaches the capacity upper limit of the tank or when the volume of the positive electrode suspension solution in the positive electrode liquid preparation tank reaches the capacity lower limit of the tank, and closing the positive electrode liquid distribution valve; the preparation process of the negative electrode suspension solution is consistent with the preparation process of the positive electrode suspension solution.

The method further includes: transferring and transporting the positive electrode suspension solution when the content of the positive electrode suspension solution in the positive electrode liquid collection tank reaches the capacity upper limit or when the content of the positive electrode suspension solution in the positive electrode liquid preparation tank reaches the capacity lower limit; and transferring and transporting the negative electrode suspension solution when the content of the negative electrode suspension solution in the negative electrode liquid collection tank reaches the capacity upper limit or when the content of the negative electrode suspension solution in the negative electrode liquid preparation tank reaches the capacity lower limit.

The transferring and transporting process of the positive electrode suspension solution includes: lowering the positive electrode transportation tank to below the positive electrode liquid collection tank via a mechanical lifting device when the content of the positive electrode suspension solution in the positive electrode liquid collection tank reaches the capacity upper limit, and adjusting the gas pressure in the positive electrode transportation tank via a pressure stabilizer and a pressure limiter to make the gas pressure in the positive electrode transportation tank lower than the gas pressure in the positive electrode liquid collection tank by 0 to 0.5 atmospheric pressure, and keeping the gas pressure constant; connecting the positive electrode transportation tank and the positive electrode liquid collection tank via a sealed tube to make the positive electrode suspension solution in the positive electrode liquid collection tank flow into the positive electrode transportation tank under the action of gravity and gas pressure, and disconnecting the positive electrode transportation tank and the positive electrode liquid collection tank until the positive electrode suspension solution in the positive electrode liquid collection tank reaches the capacity lower limit or until the volume of the positive electrode suspension solution in the positive electrode transportation tank reaches the capacity upper limit; lifting the positive electrode transportation tank to above the positive electrode liquid preparation tank via a mechanical lifting device when the content of the positive electrode suspension in the positive electrode liquid preparation tank reaches the capacity lower limit, and adjusting the gas pressure in the positive electrode transportation tank via a pressure stabilizer and a pressure limiter to make the gas pressure in the positive electrode transportation tank higher than the gas pressure in the positive electrode liquid preparation tank by 0 to 0.5 atmospheric pressure, and keeping the gas pressure constant, and connecting the positive electrode transportation tank and the positive electrode liquid preparation tank via a sealed tube to make the positive electrode suspension solution in the positive electrode transportation tank flow into the positive electrode liquid preparation tank under the action of gravity and gas pressure, and disconnecting the positive electrode transportation tank and the positive electrode liquid preparation tank when the positive electrode suspension solution in the positive electrode transportation tank completely flows into the positive electrode liquid preparation tank or when the volume of the positive electrode suspension solution of the positive electrode liquid preparation tank reaches the capacity upper limit; the transferring and transporting process of the negative electrode suspension solution is consistent with the transferring and transporting process of the positive electrode suspension solution.

In the pump-free lithium ion flow battery according to the embodiments of the invention, the electrode suspension solution is circulated via gravity and gas pressure, thus the operation is simple, and it is convenient for control; especially, the use of a liquid pump may be avoided, thereby the mechanical loss in the battery circulation system may be reduced, and hidden safety risk of the fluid flow battery may be lowered, and at the same time, the battery efficiency and the safety performance may be improved. In the preparation method of an electrode suspension solution according to the embodiments of the invention, an insulative valve is used skillfully, and by controlling the insulative valve, the probability of short circuiting in the prior art caused by the electron conductivity in the electrode suspension solution when battery reactors are connected in series may be eliminated, thus the problem that it is difficult to connect lithium ion fluid flow batteries in series may be solved.

In addition, one embodiment of the invention further provides a battery reactor for a pump-free lithium ion flow battery, wherein a corrugated plate is employed as a current collecting plate, thus the electrode suspension solution can be made to uniformly flow into each chamber, the flowability of the electrode suspension can be improved, and at the same time, the current collecting area can be enlarged, thus the magnification feature of the battery can be improved effectively; because a steering cap is set on the lateral surfaces of adjacent two layers of battery modules, the electrode suspension solution can be made to flow through each layer of battery module in turn, and an S-shaped flow field is formed, the flow rate of the electrode suspension solution is increased, and the effective volume for battery reaction is added, thus the energy density of the battery may be improved greatly, and at the same time, the electrode suspension solution in each layer of battery module can be made to flow uniformly; an inert protection gas can enter the battery reactor via a gas channel of the gas protection chamber and the cooling plate, thus the air tightness and the thermal diffusivity of the whole battery reactor may be guaranteed, and at the same time, the aqueous vapor and oxygen gas in the air, which may influence the utilization of the battery, can be isolated from the electrode suspension solution; moreover, due to the feeding diversion chamber and the discharging diversion chamber being provided with a main channel and a subchannel, the influence of a turbulence phenomenon caused by liquid feeding and discharging on the homogeneity of the battery can be reduced.

### BRIEF DESCRIPTION OF THE DRAWINGS

In order to more clearly illustrate the technical solutions of the embodiments of the invention or of the prior art, the drawings needed in the description of the embodiments or the prior art will be briefly introduced below. Apparently, the drawings in the description below are only some embodiments of the invention, and other drawings may also be obtained by one of ordinary skills in the art according to these drawings without creative work.

FIG. 1 is a structural representation of a lithium ion flow battery in the prior art;

FIG. 2 is a schematic diagram of a pump-free lithium ion flow battery according to one embodiment of the invention;

FIG. 3 is a schematic diagram of a battery subsystem that contains one battery reactor according to one embodiment of the invention;

FIG. 4 is a schematic diagram of a battery subsystem in which battery reactors are arranged in a transversal arrangement mode according to one embodiment of the invention;

FIG. 5 is a schematic diagram of a battery subsystem in which battery reactors are arranged in a longitudinal arrangement mode according to one embodiment of the invention;

FIG. 6 is a schematic diagram of a battery subsystem in which battery reactors are arranged in an array mode according to one embodiment of the invention;

FIG. 7 is a structural representation of tank for a pump-free lithium ion flow battery according to one embodiment of the invention;

FIG. 8 is a schematic sectional view of a tank for pump-free lithium ion flow battery according to one embodiment of the invention;

FIG. 9 is a schematic diagram of a pump-free lithium ion flow battery containing a transition tank according to one embodiment of the invention;

FIG. 10 is a schematic diagram of a pump-free lithium ion flow battery containing a safeguard system according to one embodiment of the invention;

FIG. 11 is a structural representation of a current collecting plate for a battery reactor according to one embodiment of the invention, wherein, (a) is a three-dimensional diagram, and (b) is a sectional view;

FIG. 12 is a schematic diagram of a structure in which a porous separater and a current collecting plate of a battery reactor are stacked with each other according to one embodiment of the invention;

FIG. 13 is a structural representation of a battery module according to one embodiment of the invention;

FIG. 14 is a structural representation of a feeding diversion chamber according to one embodiment of the invention, wherein, (a) is a three-dimensional diagram, (b) is a sectional view taken along line M-M′ in Fig. (a), and (c) is a sectional view taken along line L-L′ in Fig. (a);

FIG. 15 is a structural representation in which a feeding diversion chamber and a discharging diversion chamber are respectively set on the upside and the underside of a battery stack according to one embodiment of the invention;

FIG. 16 is a structural representation in which four steering caps set on the side A of the battery stack are connected together according to one embodiment of the invention;

FIG. 17 is a structural representation in which a feeding diversion chamber and a discharging diversion chamber are set on the upper part and the lower part of a battery stack and steering caps are set around the battery stack according to one embodiment of the invention;

FIG. 18 is a structural representation of a gas protection chamber according to one embodiment of the invention; and

FIG. 19 is a operation principle diagram of a pump-free lithium ion flow battery reactor according to one embodiment of the invention.

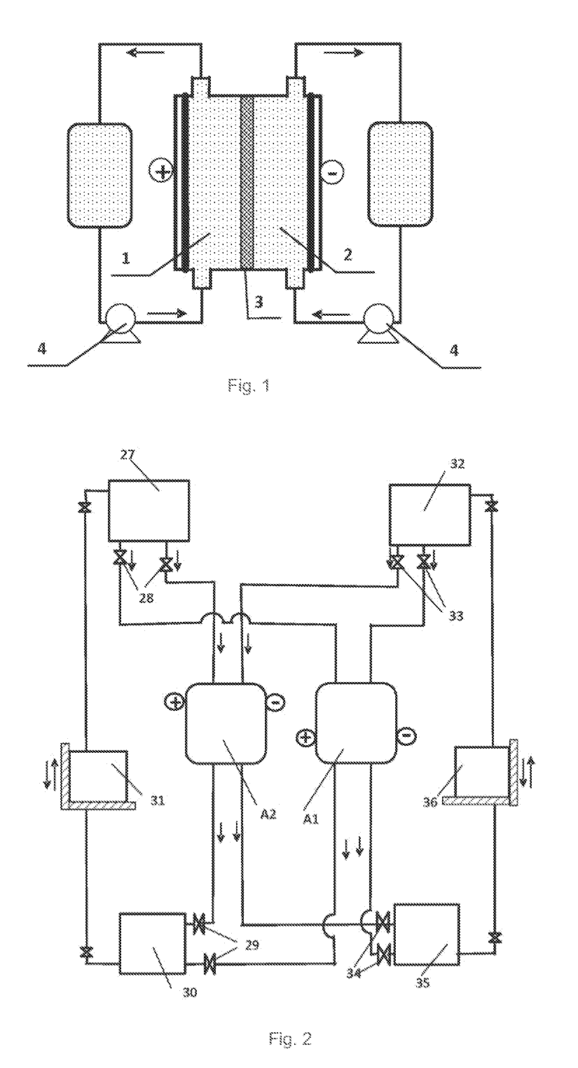

### LIST OF REFERENCE NUMBERS

1-Positive electrode Reacting Chamber; 2-Negative electrode Reacting Chamber; 3-Diaphragm; 4-Liquid Pump; 5-Tank; 6-Inlet; 7-Outlet; 8-Gas Storage System; 9-Gas Collection System; 10-Liquid Feed Port; 11-Liquid Discharge Port; 12-Positive electrode Liquid Feed Port; 13-Negative electrode Liquid Feed Port; 14-Positive electrode Liquid Discharge Port; 15-Negative electrode Liquid Discharge Port; 16-Positive electrode Liquid Feed Tank; 17-Positive electrode Liquid Feed Valve; 18-Battery Reactor; 19-Positive electrode Liquid Discharge Valve; 20-Positive electrode Liquid Discharge Tank; 21-Negative electrode Liquid Feed Tank; 22-Negative electrode Liquid Feed Valve; 23-Negative electrode Liquid Discharge Valve; 24-Negative electrode Liquid Discharge Tank; 25-Positive electrode Fluid Valve; 26-Negative electrode Fluid Valve; 27-Positive electrode Liquid Preparation Tank; 28-Positive electrode Liquid Distribution Valve; 29-Positive electrode Liquid Collecting Valve; 30-Positive electrode Liquid Collection Tank; 31-Positive electrode Transportation Tank; 32-Negative electrode Liquid Preparation Tank; 33-Negative electrode Liquid Distribution Valve; 34-Negative electrode Liquid Collecting Valve; 35-Negative electrode Liquid Collection Tank; 36-Negative electrode Transportation Tank; 37-Positive electrode Liquid Preparation Transition Tank; 38-Positive electrode Liquid Preparation Transition Valve; 39-Positive electrode Liquid Collection Transition Valve; 40-Positive electrode Liquid Collection Transition Tank; 41-Negative electrode Liquid Preparation Transition Tank; 42-Negative electrode Liquid Preparation Transition Valve; 43-Negative electrode Liquid Collection Transition Valve; 44-Negative electrode Liquid Collection Transition Tank; A1, A2-Battery Subsystem; 50-Soft Gas Bag; 101-Positive electrode Suspension Solution Feeding Tank; 102-Positive electrode Inert Liquid Storage Tank; 103-Negative electrode Inert Liquid Storage Tank; 104-Negative electrode Suspension Solution Feeding Tank; 107-Positive electrode Suspension Solution Recycle Tank; 108-Positive electrode Inert Liquid Recycle Tank; 109-Negative electrode Inert Liquid Recycle Tank; 110-Negative electrode Suspension Solution Recycle Tank; 111-Suspension Solution Control Valve; 112-Gas Pressure Control Valve; 114-Inert Gas Channel; 116-Signal Collection Device; 117-Microprocessor; 118-Display Instrument; 119-Alarming And Prompting Device; 211-Insulating Layer; 201-Positive electrode Current Collecting Plate; 202-Negative electrode Current Collecting Plate; 203-Porous separater 203; 204-Cooling Plate; 205-Feeding Diversion Chamber; 206-Discharging Diversion Chamber; 207-Steering Cap; 208-Gas Protection Chamber; 212-Positive electrode Tab; 213-Negative electrode Tab; 214-Positive electrode Pole; 215-Negative electrode Pole; 241-Gas Circulation; 253-Positive electrode Diversion Chamber; 254-Negative electrode Diversion Chamber; 81-Positive electrode Liquid Inlet; 82-Negative electrode Liquid Inlet; 83-Gas inlet; 84-Gas outlet; 85-Positive electrode Pole Hole; 86-Positive electrode Main Pole; 87-Negative electrode Pole Hole; 88-Positive electrode Liquid Outlet; 89-Negative electrode Liquid Outlet

### DETAILED DESCRIPTION OF THE EMBODIMENTS

The following embodiments of the invention provide a pump-free lithium ion flow battery, a battery reactor and a preparation method of an electrode suspension solution. The technical solutions in the embodiments of the invention will be described in detail below in conjunction with the drawings of the invention in order to make the person skilled in the art better understand the solutions in the embodiments of the invention and to make the above objectives, features and advantages of the embodiments of the invention more apparent.

Referring to FIG. 2, it is a schematic diagram of a pump-free lithium ion flow battery according to one embodiment of the invention.

The pump-free lithium ion flow battery according to this embodiment includes an positive electrode liquid preparation tank 27, a negative electrode liquid preparation tank 32, an positive electrode liquid collection tank 30, a negative electrode liquid collection tank 35, an positive electrode transportation tank 31, a negative electrode transportation tank 36 and several battery subsystems A1 and A2, wherein the positive electrode liquid preparation tank 27 and the negative electrode liquid preparation tank 32 are located above said several battery subsystems, a liquid discharge port 11 of the positive electrode liquid preparation tank 27 is connected with an positive electrode liquid feed port 12 of each battery subsystem via a tube, and an positive electrode liquid distribution valve 28 is set on the tube; a liquid discharge port 11 of the negative electrode liquid preparation tank 32 is connected with a negative electrode liquid feed port 13 of each battery subsystem via a tube, and a negative electrode liquid distribution valve 33 is set on the tube; the positive electrode liquid collection tank 30 and the negative electrode liquid collection tank 35 are located below said several battery subsystems, a liquid feed port 10 of the positive electrode liquid collection tank 30 is connected with an positive electrode liquid discharge port 14 of each battery subsystem via a tube, and an positive electrode liquid collecting valve 29 is set on the tube; a liquid feed port 10 of the negative electrode liquid collection tank 35 is connected with a negative electrode liquid discharge port 15 of each battery subsystem, and a negative electrode liquid collecting valve 34 is set on the tube. Wherein, an positive electrode suspension solution and an inert gas are loaded in the positive electrode liquid preparation tank 27 and the positive electrode liquid collection tank 30, and a negative electrode suspension solution and an inert gas are loaded in the negative electrode liquid preparation tank 32 and the negative electrode liquid collection tank 35. The above positive electrode transportation tank 31 moves up and down intermittently for the transportation and transfer of the positive electrode suspension solution between the positive electrode liquid collection tank 30 and the positive electrode liquid preparation tank 27; the above negative electrode transportation tank 36 moves up and down intermittently for the transportation and transfer of the negative electrode suspension solution between the negative electrode liquid collection tank 35 and the negative electrode liquid preparation tank 32. The circuit combination mode between said several battery subsystems is a series connection mode. During the operation of the lithium ion flow battery, at most one battery subsystem is in communication with the positive electrode liquid preparation tank 27, the positive electrode liquid collection tank 30, the negative electrode liquid preparation tank 32 or the negative electrode liquid collection tank 35.

The battery subsystem includes an positive electrode liquid feed tank 16, a negative electrode liquid feed tank 21, an positive electrode liquid discharge tank 20, a negative electrode liquid discharge tank 24 and an positive electrode liquid feed port 12, an positive electrode liquid discharge port 14, a negative electrode liquid feed port 13, a negative electrode liquid discharge port 15 and several battery reactors 18. Each battery reactor 18 includes an positive electrode reacting chamber 1 and a negative electrode reacting chamber 2, and the above positive electrode liquid feed tank 16 and the negative electrode liquid feed tank 21 are located above the battery reactors 18; the liquid feed port of the positive electrode liquid feed tank 16 is the positive electrode liquid feed port 12 of the battery subsystem, the liquid discharge port of the positive electrode liquid feed tank 16 is connected with the positive electrode reacting chamber 1 of the battery reactor 18 via a tube, and an positive electrode liquid feed valve 17 is set therebetween; the liquid feed port of the negative electrode liquid feed tank 21 is the negative electrode liquid feed port 13 of the battery subsystem, the liquid discharge port of the negative electrode liquid feed tank 21 is connected with the negative electrode reacting chamber 2 of the battery reactor 18 via a tube, and a negative electrode liquid feed valve 22 is set therebetween, and the above positive electrode liquid discharge tank 20 and the negative electrode liquid discharge tank 24 are located below the battery reactor 18; the liquid feed port of the positive electrode liquid discharge tank 20 is connected with the positive electrode reacting chamber 1 of the battery reactor 18 via a tube, and an positive electrode liquid discharge valve 19 is set therebetween, and the liquid discharge port of the positive electrode liquid discharge tank 20 is the positive electrode liquid discharge port 14 of the battery subsystem; the liquid feed port of the negative electrode liquid discharge tank 24 is connected with the negative electrode reacting chamber 2 of the battery reactor 18 via a tube and a negative electrode liquid discharge valve 23 is set therebetween, and the liquid discharge port of the negative electrode liquid discharge tank 24 is the negative electrode liquid discharge port 15 of the battery subsystem; wherein, an positive electrode suspension solution and an inert gas are loaded in the positive electrode liquid feed tank 16 and the positive electrode liquid discharge tank 20, and a negative electrode suspension solution and an inert gas are loaded in the negative electrode liquid feed tank 21 and the negative electrode liquid discharge tank 24.

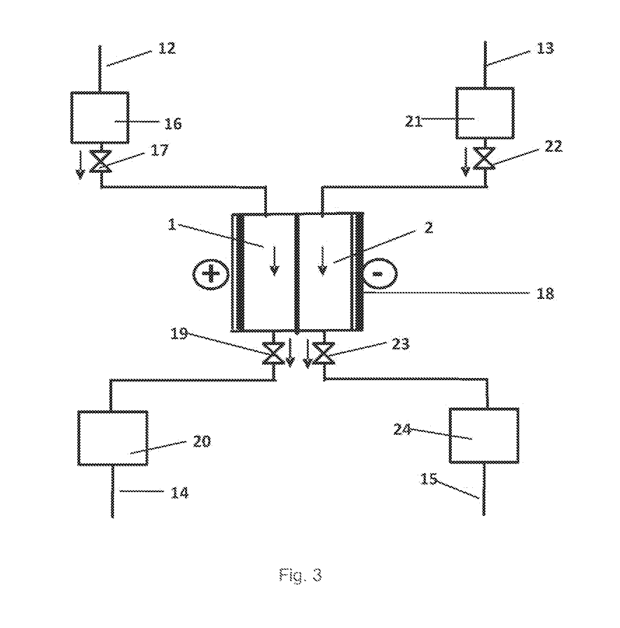

One or a plurality of battery reactors 18 may exist inside a battery subsystem. The circuit combination mode between the plurality of battery reactors 18 is a parallel connection mode, and the plurality of battery reactors 18 may be arranged transversally from left to right, or arranged longitudinally from top to bottom, or may be arranged in an array consisted of a plurality of transversal arrangements and a plurality of longitudinal arrangements. Subsequently, battery subsystems with battery reactors in different arrangement modes will be described respectively in conjunction with FIG. 3 to FIG. 6.

In the pump-free lithium ion flow battery according to the invention, the circulation of the electrode suspension solution is promoted by gravity and inert gas pressure, and thus the operation is simple, and it is convenient for control; especially, the use of a liquid pump may be avoided, thus the mechanical loss of the battery system may be lowered greatly, and the overall efficiency and safety performance of the battery may be improved.

Referring to FIG. 3, it is a schematic diagram of a battery subsystem that contains one battery reactor according to one embodiment of the invention.

The battery subsystem include: one battery reactor 18, one positive electrode liquid feed tank 16, one positive electrode liquid discharge tank 20, one negative electrode liquid feed tank 21 and one negative electrode liquid discharge tank 24. The positive electrode liquid feed tank 16, the positive electrode reacting chamber 1 and the positive electrode liquid discharge tank 20 are arranged in turn from top to bottom; and the negative electrode liquid feed tank 21, the negative electrode reacting chamber 2 and the negative electrode liquid discharge tank 24 are arranged in turn from top to bottom. Wherein, the positive electrode reacting chamber 1 of the battery reactor 18 is respectively connected with the liquid discharge port 11 of the positive electrode liquid feed tank 16 and the liquid feed port 10 of the positive electrode liquid discharge tank 20 via a sealed tube, an positive electrode liquid feed valve 17 is set between the positive electrode reacting chamber 1 and the positive electrode liquid feed tank 16, and an positive electrode liquid discharge valve 19 is set between the positive electrode reacting chamber 1 and the positive electrode liquid discharge tank 20; the negative electrode reacting chamber 2 of the battery reactor 18 is respectively connected with the liquid discharge port 11 of the negative electrode liquid feed tank 21 and the liquid feed port 10 of the negative electrode liquid discharge tank 24 via a sealed tube, a negative electrode liquid feed valve 22 is set between the negative electrode reacting chamber 2 and the negative electrode liquid feed tank 21, and a negative electrode liquid discharge valve 23 is set between the negative electrode reacting chamber 2 and the negative electrode liquid discharge tank 24.

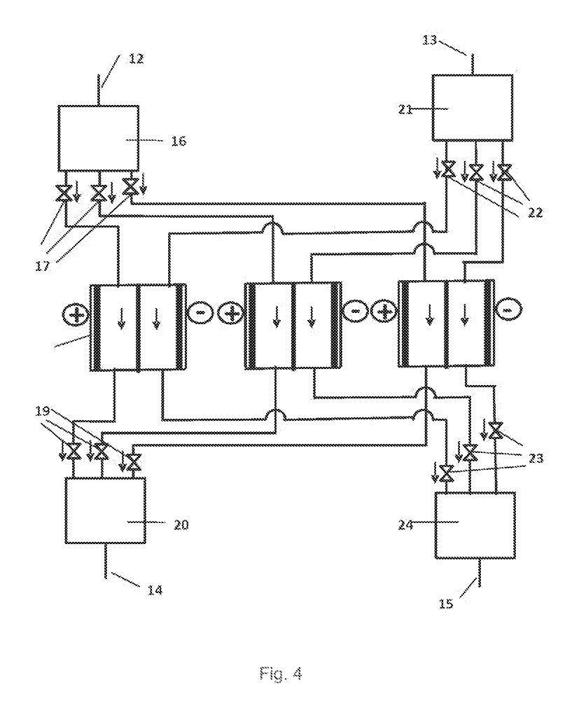

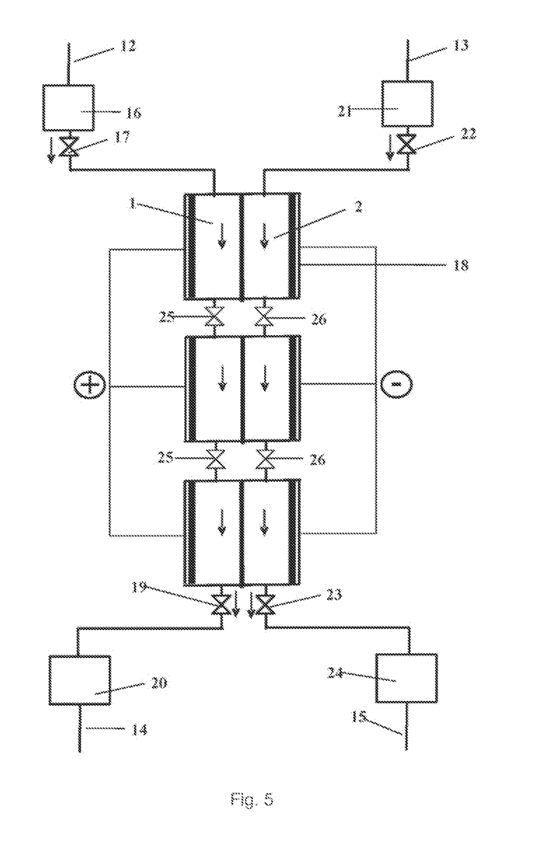

Referring to FIG. 4, it is a schematic diagram of a pump-free lithium ion flow battery subsystem in which a plurality of battery reactors are arranged transversally according to one embodiment of the invention.

The battery subsystem includes: three battery reactors 18, one positive electrode liquid feed tank 16, one positive electrode liquid discharge tank 20, one negative electrode liquid feed tank 21 and one negative electrode liquid discharge tank 24. The three battery reactors 18 are arranged transversally from left to right. The positive electrode liquid feed tank 16, the positive electrode reacting chamber 1 and the positive electrode liquid discharge tank 20 are arranged in turn from top to bottom; the negative electrode liquid feed tank 21, the negative electrode reacting chamber 2 and the negative electrode liquid discharge tank 24 are arranged in turn from top to bottom. Wherein, the positive electrode reacting chambers 1 of the three battery reactors 18 are respectively connected with the liquid discharge port 11 of the positive electrode liquid feed tank 16 and the liquid feed port 10 of the positive electrode liquid discharge tank 20 via a sealed tube, and an positive electrode liquid feed valve 17 is set between each positive electrode reacting chamber 1 and the positive electrode liquid feed tank 16, and an positive electrode liquid discharge valve 19 is set between each positive electrode reacting chamber 1 and the positive electrode liquid discharge tank 20; the negative electrode reacting chambers 2 of the three battery reactor 18 are respectively connected with the liquid discharge port 11 of the negative electrode liquid feed tank 21 and the liquid feed port 10 of the negative electrode liquid discharge tank 24 via a sealed tube, and a negative electrode liquid feed valve 22 is set between each negative electrode reacting chamber 2 and the negative electrode liquid feed tank 21, and a negative electrode liquid discharge valve 23 is set between each negative electrode reacting chamber 2 and the negative electrode liquid discharge tank 24.

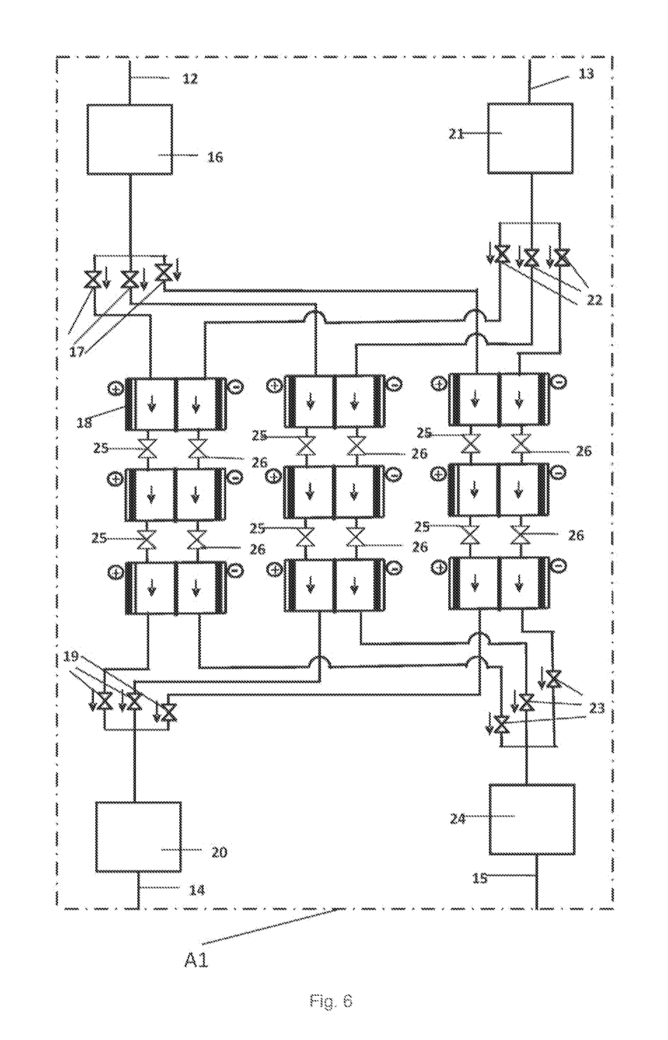

Referring to FIG. 5, it is a schematic diagram of a pump-free lithium ion flow battery subsystem in which a plurality of battery reactors are arranged longitudinally according to one embodiment of the invention.

The battery subsystem includes: three battery reactors 18, one positive electrode liquid feed tank 16, one positive electrode liquid discharge tank 20, one negative electrode liquid feed tank 21 and one negative electrode liquid discharge tank 24. The three battery reactors 18 are arranged longitudinally from top to bottom. The positive electrode liquid feed tank 16, the positive electrode reacting chamber 1 and the positive electrode liquid discharge tank 20 are arranged in turn from top to bottom; and the negative electrode liquid feed tank 21, the negative electrode reacting chamber 2 and the negative electrode liquid discharge tank 24 are arranged in turn from top to bottom. Wherein, the three battery reactors 18 are arranged from top to bottom, the three positive electrode reacting chambers 1 are connected in turn via a sealed tube, and the three negative electrode reacting chambers 2 are connected in turn via a sealed tube. An positive electrode fluid valve 25 is set between the positive electrode reacting chamber 1 and the positive electrode reacting chamber 1, and a negative electrode fluid valve 26 is set between the negative electrode reacting chamber 2 and the negative electrode reacting chamber 2. The positive electrode reacting chamber 1 located on the top is connected with the liquid discharge port 11 of the positive electrode liquid feed tank 16 via a sealed tube, and the negative electrode reacting chamber 2 located on the top is connected with the liquid discharge port 11 of the negative electrode liquid feed tank 21 via a sealed tube; the positive electrode reacting chamber 1 located on the bottom is connected with the liquid feed port 10 of the positive electrode liquid discharge tank 20 via a sealed tube, and the negative electrode reacting chamber 2 located on the bottom is connected with liquid feed port 10 of the negative electrode liquid discharge tank 24 via a sealed tube. An positive electrode liquid feed valve 17 is set between the top positive electrode reacting chamber 1 and the positive electrode liquid feed tank 16, and a negative electrode liquid feed valve 22 is set between the top negative electrode reacting chamber 2 and the negative electrode liquid feed tank 21; an positive electrode liquid discharge valve 19 is set between the bottom positive electrode reacting chamber 1 and the positive electrode liquid discharge tank 20, and a negative electrode liquid discharge valve 23 is set between the bottom negative electrode reacting chamber 2 and the negative electrode liquid discharge tank 24.

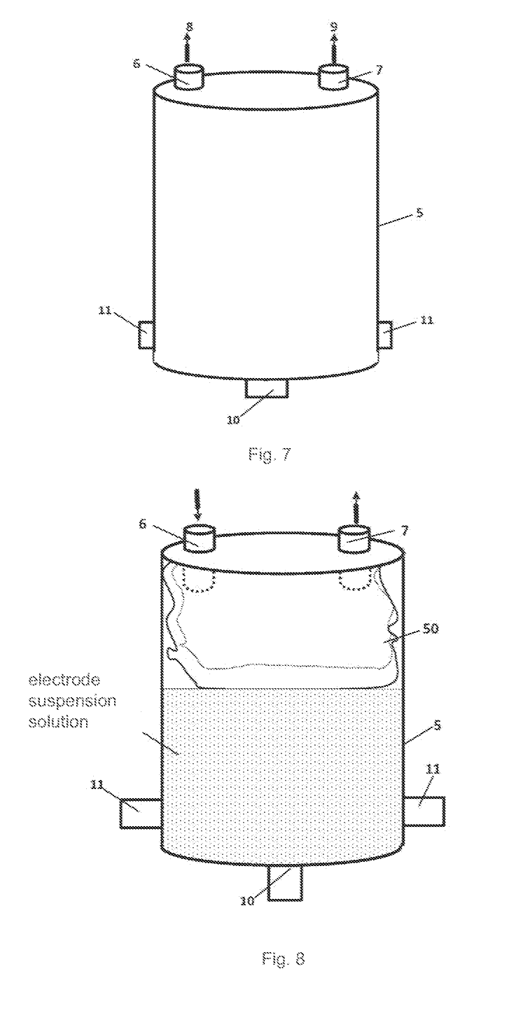

Referring to FIG. 6, it is a schematic diagram of a pump-free lithium ion flow battery subsystem in which a plurality of battery reactors are arranged in an array according to one embodiment of the invention.

The battery subsystem includes: nine battery reactors 18, one positive electrode liquid feed tank 16, one positive electrode liquid discharge tank 20, one negative electrode liquid feed tank 21 and one negative electrode liquid discharge tank 24. Wherein, the nine battery reactors 18 are arranged transversally and longitudinally to form an array, that is, three battery reactors 18 form a group, and nine battery reactors 18 are totally divided into three groups, and the three battery reactors 18 in each group are connected in the mode of FIG. 4, and the three groups of battery reactors 18 are connected in parallel according to the mode of FIG. 3.

Referring to FIG. 7, it is a structural representation of tank for a pump-free lithium ion flow battery according to one embodiment of the invention.

In conjunction with the embodiments shown in the above FIG. 2 to FIG. 6, the positive electrode liquid preparation tank 27, the negative electrode liquid preparation tank 32, the positive electrode liquid collection tank 30, the negative electrode liquid collection tank 35, the positive electrode transportation tank 31 and the negative electrode transportation tank 36, and the positive electrode liquid feed tank 16, the negative electrode liquid feed tank 21, the positive electrode liquid discharge tank 20 and the negative electrode liquid discharge tank 24 according to the embodiments of the invention all include one or more liquid feed ports 10 located on the bottom surface of the tank 5 and one or more liquid discharge ports 11 located on the lateral surface of the tank 5; an inert gas inlet 6 and an outlet 7 are set on the top of the tank 5, wherein the inlet 6 is connected with a gas storage system 8, and the outlet 7 is connected with a gas collection system 9; a pressure stabilizer is set at the inlet 6, and a pressure limiter is set at the outlet 7, wherein the pressure stabilizer and the pressure limiter adjust the gas pressure in the tank 5 and keep it constant; the inert gas recycled to the gas collection system 9 may enter the gas storage system 8 for cyclic utilization after purification and pressurization.

The material of the storage tanks for the pump-free lithium ion flow battery according to the embodiments of the invention may be stainless steel, PE (polyethylene) and PP (polypropylene), etc., and the wall thickness may be in the range of 1-10 mm.

Referring to FIG. 8, it is a schematic sectional view of a tank for pump-free lithium ion flow battery according to one embodiment of the invention.

In FIG. 8, a soft gas bag 50 is fixedly set on the top inside of the tank 5, and the soft gas bag 50 is connected with the inlet 6 and the outlet 7. The soft gas bag 50 is configured for pressurizing the positive electrode suspension solution or the negative electrode suspension solution by controlling the inert gas filled in, so as to discharge the positive electrode suspension solution or the negative electrode suspension solution from the liquid discharge port 11. The inert gas includes nitrogen gas or argon gas, and the gas pressure is in the range of 0.1-0.5 Mpa.

Wherein, the material of the soft gas bag 50 may be PE and PP, etc., which can bear a gas pressure of 0.5 Mpa and higher. The soft gas bag 50 is fixed on the top inside of the tank 5, and is in communication with the inlet 6 and the outlet 7, and its volume when filled with an inert gas is smaller than or equal to the volume of the tank.

During the operation of the battery, when the electrode suspension in the storage tank reaches the capacity upper limit of the tank 5, the corresponding valve body on the sealed tube is opened, and at the same time, an inert gas is fed from the inlet 6 of the storage tank to the soft gas bag 50, and the soft gas bag 50 expands under the action of the gas pressure, and the electrode suspension solution in the storage tank flows into the battery subsystem or the next storage tank under the action of gravity and the expansion of the soft gas bag 50.

By placing a soft gas bag in the liquid preparation tank, it may be avoided that the inert gas directly contacts the electrode suspension solution and the electrode suspension solution is influenced by the water and oxygen in the low-purity gas; as a result, the pressurized propulsion action on the electrode suspension solution may be attained without the need to employing a high-purity gas, and the cost may be lowered.

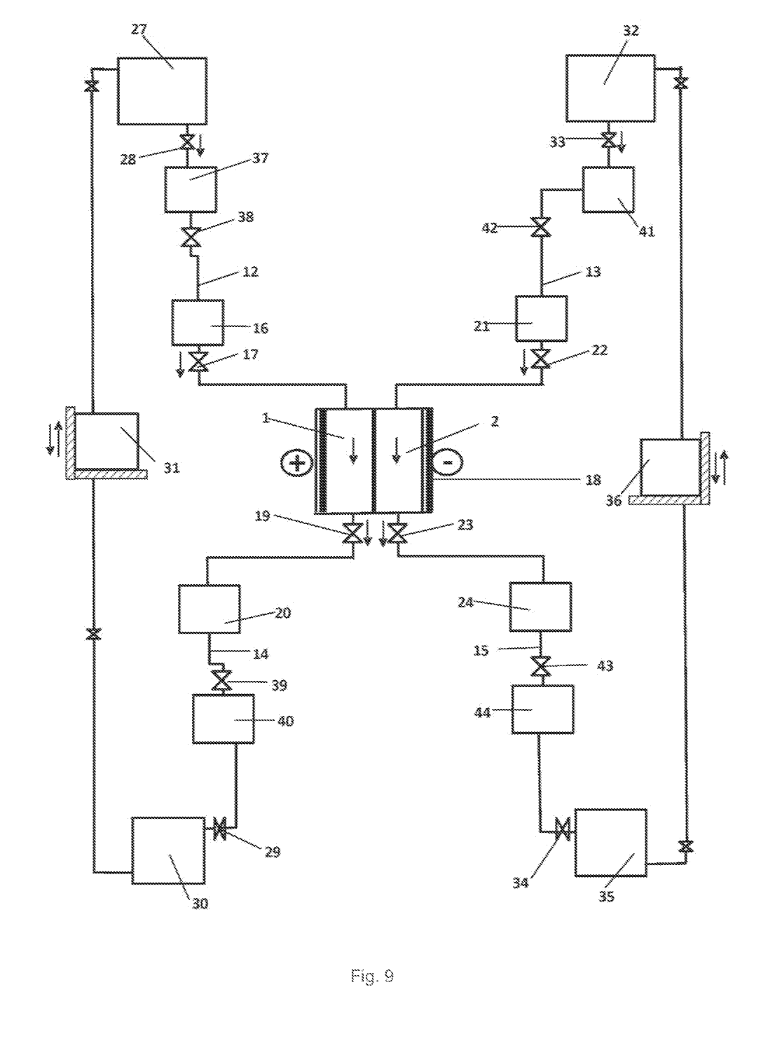

Referring to FIG. 9, it is a schematic diagram of a pump-free lithium ion flow battery containing a transition tank according to one embodiment of the invention.

In comparison with the pump-free lithium ion flow battery shown in FIG. 2, in the pump-free lithium ion flow battery shown in FIG. 9, one or more positive electrode liquid preparation transition tanks 37 are added between the positive electrode liquid preparation tank 27 and the positive electrode liquid feed tank 16; one or more negative electrode liquid preparation transition tanks 41 are added between the negative electrode liquid preparation tank 32 and the negative electrode liquid feed tank 21; one or more positive electrode liquid collection transition tanks 40 are added between the positive electrode liquid discharge tank 20 and the positive electrode liquid collection tank 30; and one or more negative electrode liquid collection transition tanks 44 are added between the negative electrode liquid discharge tank 24 and the negative electrode liquid collection tank 35.

As shown in FIG. 9, the pump-free lithium ion flow battery including a transition tank according to this embodiment includes: one positive electrode liquid preparation tank 27, one positive electrode liquid preparation transition tank 37, one negative electrode liquid preparation tank 32, one negative electrode liquid preparation transition tank 41, one positive electrode liquid collection tank 30, one positive electrode liquid collection transition tank 40, one negative electrode liquid collection tank 35, one negative electrode liquid collection transition tank 44, one positive electrode transportation tank 31, one negative electrode transportation tank 36, two mechanical lifting devices, one gas storage cylinder, one gas exhaust cylinder and one battery subsystem set forth in embodiment 4. The positive electrode liquid preparation tank 27, the positive electrode liquid preparation transition tank 37, the negative electrode liquid preparation tank 32 and the negative electrode liquid preparation transition tank 41 are located above the battery subsystem, and the positive electrode liquid collection tank 30, the positive electrode liquid collection transition tank 40, the negative electrode liquid collection tank 35 and the negative electrode liquid collection transition tank 44 are located below the battery subsystem. The positive electrode liquid preparation tank 27, the positive electrode liquid preparation transition tank 37, the positive electrode liquid feed port 12 of the battery subsystem, the positive electrode liquid discharge port 14 of the battery subsystem, the positive electrode liquid collection transition tank 40 and the positive electrode liquid collection tank 30 are arranged from top to bottom and connected in turn via a sealed tube; the negative electrode liquid preparation tank 32, the negative electrode liquid preparation transition tank 41, the negative electrode liquid feed port 13 of the battery subsystem, the negative electrode liquid discharge port 15 of the battery subsystem, the negative electrode liquid collection transition tank 44 and the negative electrode liquid collection tank 35 are arranged from top to bottom and connected in turn via a sealed tube.

An positive electrode liquid distribution valve 28 is set between the positive electrode liquid preparation tank 27 and the positive electrode liquid preparation transition tank 37, an positive electrode liquid preparation transition valve 38 is set between the positive electrode liquid preparation transition tank 37 and the positive electrode liquid feed port 12 of the battery subsystem, an positive electrode liquid collection transition valve 39 is set between the positive electrode liquid discharge port 14 of the battery subsystem and the positive electrode liquid collection transition tank 40, and an positive electrode liquid collecting valve 29 is set between the positive electrode liquid collection transition tank 40 and the positive electrode liquid collection tank 30.

A negative electrode liquid distribution valve 33 is set between the negative electrode liquid preparation tank 32 and the negative electrode liquid preparation transition tank 41, a negative electrode liquid preparation transition valve 42 is set between the negative electrode liquid preparation transition tank 41 and the negative electrode liquid feed port 13 of the battery subsystem, a negative electrode liquid collection transition valve 43 is set between the negative electrode liquid discharge port 15 of the battery subsystem and the negative electrode liquid collection transition tank 44, and a negative electrode liquid collecting valve 34 is set between the negative electrode liquid collection transition tank 44 and the negative electrode liquid collection tank 35. The positive electrode transportation tank 31 may move up and down with the aid of a mechanical device, for the transportation of the positive electrode suspension solution between the positive electrode liquid collection tank 30 and the positive electrode liquid preparation tank 27; and the negative electrode transportation tank 36 may move up and down with the aid of a mechanical device, for the transportation of the negative electrode suspension solution between the negative electrode liquid collection tank 35 and the negative electrode liquid preparation tank 32. Wherein, the inlet 6 of the tank 5 is connected with a gas storage system 8, and the outlet 7 of the tank 5 is connected with a gas collection system 9.

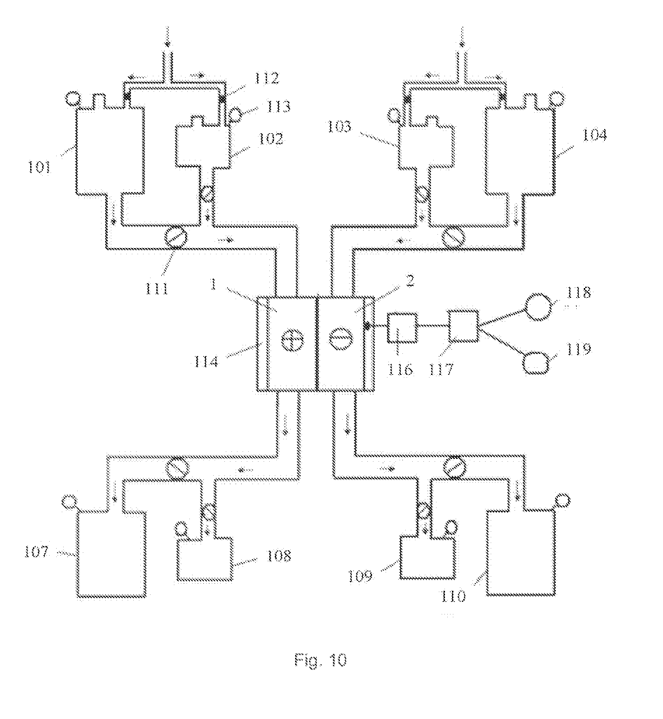

Referring to FIG. 10, it is a schematic diagram of a pump-free lithium ion flow battery containing a safeguard system according to one embodiment of the invention.

The safeguard system of the pump-free lithium ion flow battery shown in FIG. 10 includes: a battery monitoring subsystem and a suspension solution displacing device, wherein, the battery monitoring subsystem is configured for monitoring each index of the pump-free lithium ion flow battery and starting the suspension solution displacing device when abnormality occurs; the suspension solution displacing device is configured for separating the positive electrode suspension and the negative electrode suspension when abnormality occurs.

The battery monitoring subsystem includes: a signal collection device 116, a microprocessor 117, a display instrument 118 and an alarming and prompting device 119; wherein, the signal collection device 116, the display instrument 118 and the alarming and prompting device 119 are respectively connected with the microprocessor 117; the signal collection device 116 includes a current sensor, a voltage sensor, a temperature sensor and a gas composition analysis sensor.

The current sensor and the voltage sensor are connected with the positive electrode and the negative electrode of the battery reactor for respectively testing the current and voltage during the charging and discharging of the battery reactor.

The temperature sensor and the gas composition analysis sensor are set in an inert gas channel of the battery reactor, for respectively monitoring the real-time temperature and gas composition change of the battery reactor.

The microprocessor 117 is configured for analyzing the current, voltage, temperature and gas composition collected by the signal collection system and starting the suspension solution displacing device when the analysis result is abnormal.

The alarming and prompting device 119 is configured for alarming when the analysis result is abnormal.

The data display instrument 118 is configured for displaying the analysis result.

Abnormal conditions include, but are not limited to: 1) the current rises sharply; 2) the value of the current exceeds a set current critical value; 3) the voltage falls sharply; 4) the temperature rises sharply; 5) the value of the temperature is larger than a set temperature critical value; 6) the content of a certain composition of CH4, CO2 or the volatilized gas of carbonic ester solvent in the gas composition analysis result rises sharply or exceeds a set critical value.

A suspension solution displacing device according to one embodiment of the invention includes an inert gas pressure control unit (not shown in FIG. 10), a sealed tube, and a suspension control valve 111 and a gas pressure control valve 112, wherein, the inert gas pressure control unit is respectively connected with the positive electrode reacting chamber 1 and the negative electrode reacting chamber 2 of the battery reactor via a sealed tube and a control valve; when the suspension displacing device is started, by controlling the opening or closing of the suspension solution control valve 111 and the gas pressure control valve 112, the positive electrode suspension solution is made to flow into an positive electrode suspension solution recycle tank 107, and the negative electrode suspension solution is made to flow into a negative electrode suspension solution recycle tank 110.

The specific process is as follows: when the suspension solution displacing device is started, the suspension solution control valves 111 between the battery reactor and the positive electrode suspension solution feeding tank 101, the negative electrode suspension solution feeding tank 104 are closed, and the suspension solution feeding pipes are disconnected; the gas pressure control valve of an inert gas pressure control system is adjusted, the gas pressure control valves 112 between the inert gas and the positive electrode suspension solution feeding tank 101, the negative electrode suspension solution feeding tank 104 are closed, and the gas pressure control valves 112 between the inert gas and the positive electrode reacting chamber and the negative electrode reacting chamber of the battery reactor are opened, the gas flow path is changed, and under the pressure of the inert gas, the positive electrode suspension solution flows into the positive electrode suspension solution recycle tank 107, and the negative electrode suspension solution flows into a negative electrode suspension solution recycle tank 110.

Another suspension solution displacing device according to one embodiment of the invention includes an positive electrode inert liquid storage tank 102, an positive electrode inert liquid recycle tank 108, a negative electrode inert liquid storage tank 103, a negative electrode inert liquid recycle tank 109, an inert gas pressure control unit, a sealed tube, a suspension control valve 111 and a gas pressure control valve 112; when the suspension solution displacing device is started, by controlling the opening or closing of the suspension solution control valve 111 and the gas pressure control valve 112, the positive electrode inert liquid is fed into the positive electrode reacting chamber 1 of the battery reactor, mixed with the positive electrode suspension solution and then flows into the positive electrode inert liquid recycle tank 108, and the negative electrode inert liquid is fed into the negative electrode reacting chamber 2 of the battery reactor, mixed with the negative electrode suspension solution and then flows into the negative electrode inert liquid recycle tank 109.

The specific process is as follows: the suspension solution control valves 111 between the battery reactor and the positive electrode suspension solution feeding tank 101, the positive electrode suspension solution recycle tank 107, the negative electrode suspension solution feeding tank 104, the negative electrode suspension solution recycle tank 110 are closed, the suspension solution flow channel is disconnected, and the suspension solution control valves 111 between the battery reactor and the positive electrode inert liquid storage tank 102, the positive electrode inert liquid recycle tank 108, the negative electrode inert liquid storage tank 103, the negative electrode inert liquid recycle tank 109 are opened, and the inert liquid flow channels will be connected; at the same time, the gas pressure control valve 112 of the inert gas pressure control system is adjusted, the gas pressure control valves 112 between the inert gas and the positive electrode suspension solution feeding tank 101, the negative electrode suspension solution feeding tank 104 are closed, and the suspension solution control valves 111 between the inert gas and the positive electrode inert liquid storage tank 102, the negative electrode inert liquid storage tank 103 are opened, and under the pressure of the inert gas, the positive electrode inert liquid is fed into the positive electrode reacting chamber 1 of the battery reactor, mixed with the positive electrode suspension solution and then flows into the positive electrode inert liquid recycle tank 108, and the negative electrode inert liquid is fed into the negative electrode reacting chamber 2 of the battery reactor, mixed with the negative electrode suspension solution and then flows into the negative electrode inert liquid recycle tank 109.

In the pump-free lithium ion flow battery containing a safeguard system according to this embodiment, the state of the battery reactor is monitored by collecting and analyzing the current, voltage, temperature and gas composition in the battery reactor via a battery monitoring subsystem, and when abnormality occurs in the battery reactor, an alarming signal can be issued and a safety device can be started in time, so that the positive electrode suspension solution and the negative electrode suspension solution can be separated, thereby accidents may be avoided.

In the embodiments shown in the above FIG. 2 to FIG. 10, the positive electrode suspension solution may be a mixture of an positive electrode active material particle, an conductive additive and an electrolyte, wherein the positive electrode active material particle may be a mixture of one or more of lithium ferrous phosphate, lithium manganous phosphate, lithium silicate, lithium iron silicate, titanium sulfide, molybdenum sulfide, iron sulfide, doped lithium manganese oxide, lithium cobalt oxide, lithium vanadium oxide, lithium titanium oxide, lithium nickel manganese oxide, lithium nickel cobalt oxide, lithium nickel manganese cobalt oxide and other lithium-embeddable compounds; and the conductive additive is a mixture of one or more of carbon black, carbon fibre, metal particles and other electron-conducting materials.

The negative electrode suspension solution may be a mixture of a negative electrode active material particle, a conductive additive and an electrolyte, wherein the negative electrode active material particle may be a mixture of one or more of aluminum-based alloy, silicon-based alloy, tin-based alloy, lithium vanadium oxide, lithium titanium oxide and a carbon material in which lithium may be reversibly embedded; and the conductive additive may be a mixture of one or more of carbon black, carbon fibre, metal particles and other electron-conducting materials.

The material of the sealed tube may be polyethylene, polypropylene, polytetrafluor ethylene, polyvinylidene fluoride or other electron-nonconducting materials, or the material of the sealed tube may be a stainless steel or other alloy materials internally lined with polyethylene, polypropylene, polytetrafluor ethylene, polyvinylidene fluoride or other electron-nonconducting materials.

During the operation of the pump-free lithium ion flow battery according to the embodiment of the invention, the gas pressure of the positive electrode liquid feed tank 16 is kept consistent with the gas pressure of the negative electrode liquid feed tank 21, and the gas pressure in the positive electrode liquid discharge tank 20 is also kept consistent with the gas pressure in the negative electrode liquid discharge tank 24.

Referring to FIG. 11, it is a structural representation of a current collecting plate for a battery reactor according to one embodiment of the invention, wherein, (a) is a three-dimensional diagram, and (b) is a sectional view.

The current collecting plate of the battery reactor as shown in FIG. 11 is a corrugated plate with a through groove and a tab. An insulating layer 211 is coated on the outside of the convex points or the concave points of the current collecting plate. In this embodiment, the sectional waveform of the current collecting plate is a sine wave. In addition to the corrugated plate shown in FIG. 11, the sectional waveform of the current collecting plate according to one embodiment of the invention may also be square wave, triangular wave, trapezoidal wave, sawtooth wave, impulse wave, or convex-concaved abnormity wave. For easy description, in the embodiments of the invention, the positive electrode current collecting plate and the negative electrode current collecting plate are called by a joint name of current collecting plate, and the positive electrode suspension solution and the negative electrode suspension solution are called by a joint name of electrode suspension solution.

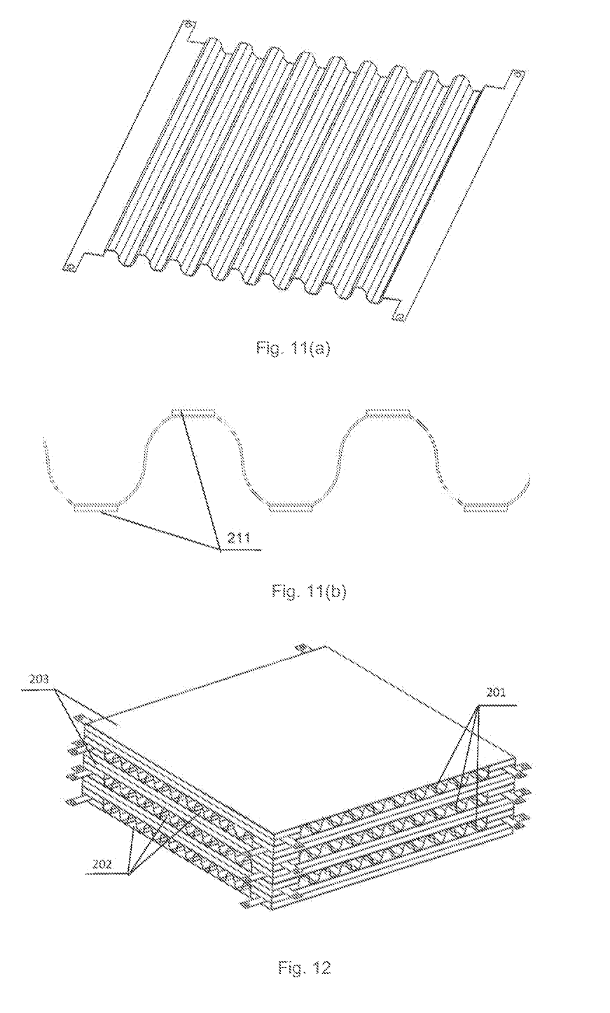

Referring to FIG. 12, it is a schematic diagram of a structure in which a porous separater and a current collecting plate of a battery reactor are stacked with each other according to one embodiment of the invention.

The battery reactor according to the embodiment of the invention includes: a porous separater 203, an positive electrode current collecting plate 201 and a negative electrode current collecting plate 202, wherein, the positive electrode current collecting plate 201, the porous separater 203 and the negative electrode current collecting plate 202 are stacked together to form a structure in which the porous separater 203 and the current collecting plate are stacked; wherein, the positive electrode current collecting plate 201 and the negative electrode current collecting plate 202 are corrugated plates with a through groove, and moreover, the direction of the through groove of the positive electrode current collecting plate 201 and the direction of the through groove of the negative electrode current collecting plate 202 are perpendicular to each other; an positive electrode current collecting plate 201 is set between two layers of porous separaters 203 to form an positive electrode reacting chamber 1, and a negative electrode current collecting plate 202 is set between two layers of porous separaters 203 to form a negative electrode reacting chamber 2, wherein the porous separaters 203 and the current collecting plate is bound and fixed along the groove direction on the two sides of the current collecting plates, and the adjacent positive electrode reacting chamber 1 and negative electrode reacting chamber 2 are bound and fixed around the edge; the positive electrode suspension solution circulates in the positive electrode reacting chamber 1 along the groove direction, and the negative electrode suspension solution circulates in the negative electrode reacting chamber 2 along the groove direction. In this embodiment, a plastic pad is respectively adhered on the two sides of the current collecting plate along the groove direction, and the porous separater and the plastic pad are bound hermetically and installed fixedly.

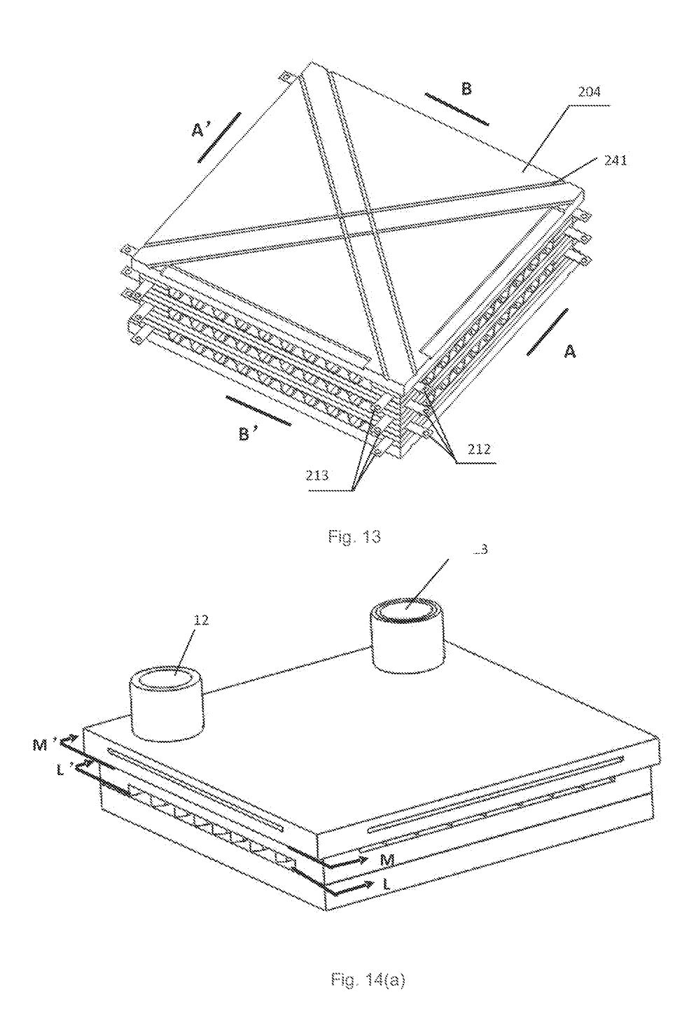

Referring to FIG. 13, it is a structural representation of a battery module according to one embodiment of the invention.

In this embodiment of the invention, the lateral surfaces on the two ends of the circulation direction of the positive electrode suspension solution are respectively side A and side A′, and the lateral surfaces on the two ends of the circulation direction of the negative electrode suspension solution are respectively side B and side B′, wherein, the side A and the side A′ are respectively perpendicular to the side B and the side B′.

The sectional waveform of the positive electrode current collecting plate 201 and the negative electrode current collecting plate 202 includes: sine wave, square wave, triangular wave, trapezoidal wave, sawtooth wave, impulse wave, or convex-concaved abnormity wave. In the embodiments of the invention, the current collecting plate is not a flat plate; instead, it is a corrugated plate. With the convex and concave waveforms of the corrugated plate, through grooves are respectively formed on the upper surface and the lower surface of the corrugated plate, so that the electrode suspension solution circulates along the direction of the through groove; moreover, the corrugated plate can make the electrode suspension solution uniformly flow into each reacting chamber, thus the flowability of the electrode suspension solution can be improved, and at the same time, the current collecting area can be enlarged, and the magnification feature of the battery can be improved effectively.

Aluminum or aluminum-coated metal plate may be employed as the material of the positive electrode current collecting plate 201, and the thickness is 0.05˜0.5 mm; copper, nickel, or a metal plate coated with copper or nickel may be employed as the material of the negative electrode current collecting plate 202, and the thickness is 0.05˜0.5 mm.

An insulating layer 211 is coated on the outside of the convex points or the concave points on the positive electrode current collecting plate or the negative electrode current collecting plate to prevent the porous separater from being damaged due to long-term usage, whereas the damage will make the contact points between the positive electrode current collecting plate and the negative electrode current collecting plate short-circuited; the thickness of the insulating layer is smaller than 0.1 mm.

As shown in FIG. 13, the lithium ion flow battery reactor of the invention further includes two cooling plates 204, a gas channel 241 is opened on the surface of the cooling plates, and a structure stacked by the porous separater and the current collecting plate is located between two cooling plates 204 to form a battery module. N battery modules are stacked together to form a battery stack, wherein, n is a natural number and n≧2. The gas channel 241 is a groove, and the inlet and the outlet of the groove are near the four corners of the cooling plate and are located outside the steering cap. The groove of the gas channel may be a continuous-form groove, for example, straight line form, arc form and curve form, etc. During the operation of the battery, the inert gas enters the battery reactor from the gas inlet of the gas protection chamber, and then it enters between two cooling plates along the inlet of the gas channel, thus it has a cooling and heat dissipation action on the battery reactor.

In this embodiment, four intercrossed through-type gas channels are opened on the surface of the cooling plate. The battery module has two pairs of lateral surfaces that are perpendicular to each other, wherein, the lateral surfaces on the two ends of the circulation direction of the positive electrode suspension solution are respectively side A and side A′, and the lateral surfaces on the two ends of the circulation direction of the negative electrode suspension solution are respectively side B and side B′. The positive electrode suspension solution flows from the side A to the side A′ of the positive electrode current collecting plate, or it flows from the side A′ to the side A; the negative electrode suspension solution flows from the side B to the side B′ of the negative electrode current collecting plate, or it flows from the side B′ to the side B. In this embodiment, four positive electrode tabs 212 are respectively set on the four vertex angles on the side A and the side A′ of the positive electrode current collecting plate, and four negative electrode tabs 213 are respectively set on the four vertex angles on the side B and the side B′ of the negative electrode current collecting plate.

An positive electrode tab 212 is respectively set on the side A and the side A′ of the positive electrode current collecting plate, and the positive electrode current collecting plates 201 of each layer is connected by the positive electrode pole 214 via the positive electrode tab 212 respectively; a negative electrode tab 213 is respectively set on the side B and the side B′ of the negative electrode current collecting plate 202, and the negative electrode current collecting plates 202 of each layer is connected by the negative electrode pole 215 via the negative electrode tab 213 respectively; the positive electrode pole 214 and the negative electrode pole 215 are respectively conductive metal rods.

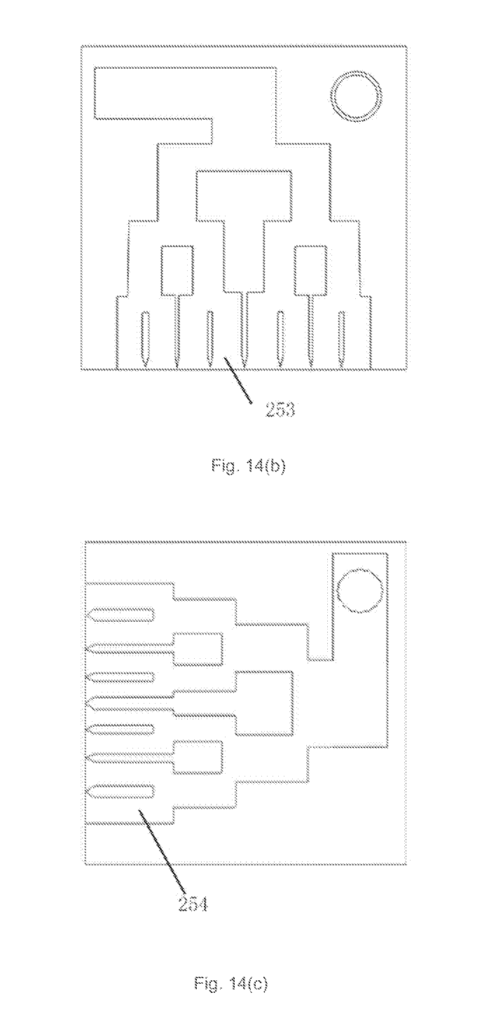

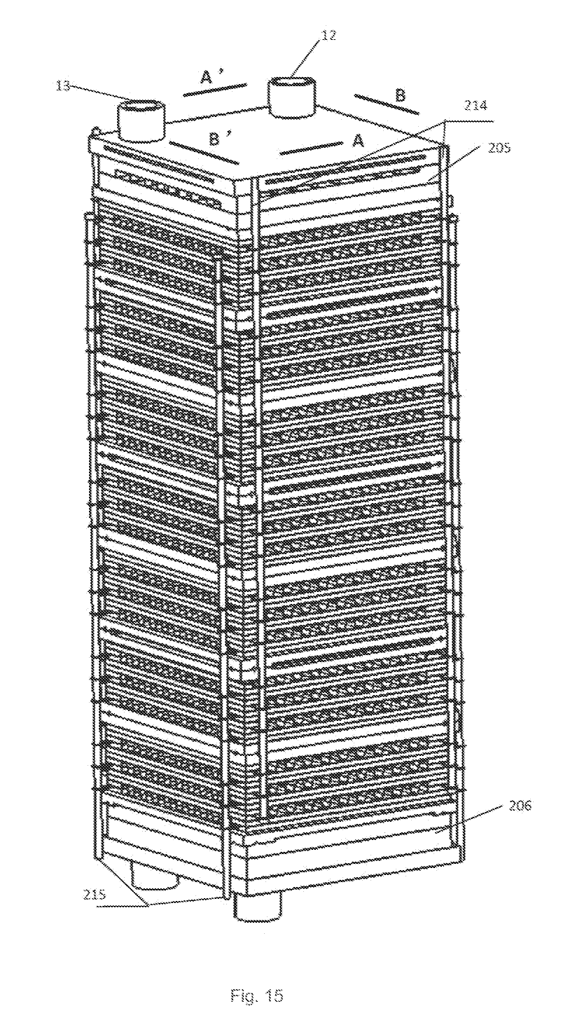

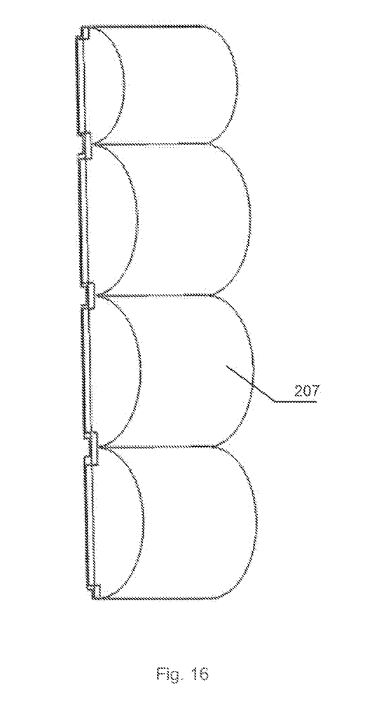

Referring to FIG. 14, it is a structural representation of a feeding diversion chamber according to one embodiment of the invention, wherein, (a) is a three-dimensional diagram, (b) is a sectional view taken along line M-M′ in Fig. (a), and (c) is a sectional view taken along line L-L′ in Fig. (a). Referring to FIG. 15, it is a structural representation in which a feeding diversion chamber and a discharging diversion chamber are respectively set on the upside and the underside of a battery stack according to one embodiment of the invention.

Wherein, the upper part and the lower part of the battery stack are respectively provided with a feeding diversion chamber 205 and a discharging diversion chamber 206, and an positive electrode diversion chamber 253 and a negative electrode diversion chamber 254 that are not in communication with each other are respectively provided inside the feeding diversion chamber 205 and the discharging diversion chamber 206; the feeding diversion chamber 205 is provided with an positive electrode liquid feed port 12 and a negative electrode liquid feed port 13, and one end of the positive electrode diversion chamber 253 and the negative electrode diversion chamber 254 is respectively connected with the positive electrode liquid feed port 12 and the negative electrode liquid feed port 13, and the other end thereof respectively leads to two perpendicular lateral surfaces of the feeding diversion chamber, i.e., the side A and the side B; the discharging diversion chamber 206 is provided with an positive electrode liquid discharge port 14 and a negative electrode liquid discharge port 15, and one end of the positive electrode diversion chamber 253 and the negative electrode diversion chamber 254 is respectively connected with the positive electrode liquid discharge port 14 and the negative electrode liquid discharge port 15, and the other end thereof respectively leads to two perpendicular lateral surfaces of the discharging diversion chamber, i.e., the side A and the side B or the side A′ and the side B′.

In FIG. 15, seven layers of battery modules are stacked together to form a battery stack, and the upper part and the lower part of the battery stack are respectively provided with a feeding diversion chamber 205 and a discharging diversion chamber 206. All the positive electrode tabs 212 on the same side are respectively connected by four positive electrode poles 214, and all the negative electrode tabs 213 on the same side are respectively connected by four negative electrode poles 215.

Referring to FIG. 16, it is a structural representation in which four steering caps set on the side A of the battery stack are connected together according to one embodiment of the invention.

Wherein, steering caps 207 are set on the same lateral surface of the feeding diversion chamber and the first layer of battery module, adjacent two layers of battery modules, and the seventh battery module and the discharging diversion chamber. In this embodiment, an positive electrode suspension solution or a negative electrode suspension solution respectively flows from the positive electrode liquid feed port or the negative electrode liquid feed port of the feeding diversion chamber into the positive electrode diversion chamber or the negative electrode diversion chamber, and flows through each positive electrode reacting chamber or negative electrode reacting chamber of each layer of battery module in turn under the diversion action of the steering cap to form an S-shaped flow field, and finally flows out from the positive electrode liquid discharge port or the negative electrode liquid discharge port of the discharging diversion chamber. By setting a steering cap on the lateral surfaces of adjacent two layers of battery modules, the electrode suspension solution can flow through each layer of battery module in turn, and an S-shaped flow field is formed, and the flow rate of the electrode suspension is increased, and the effective volume for battery reaction is added, thus the energy density of the battery may be improved greatly, and at the same time, the electrode suspension solution in each layer of battery module can flow uniformly.

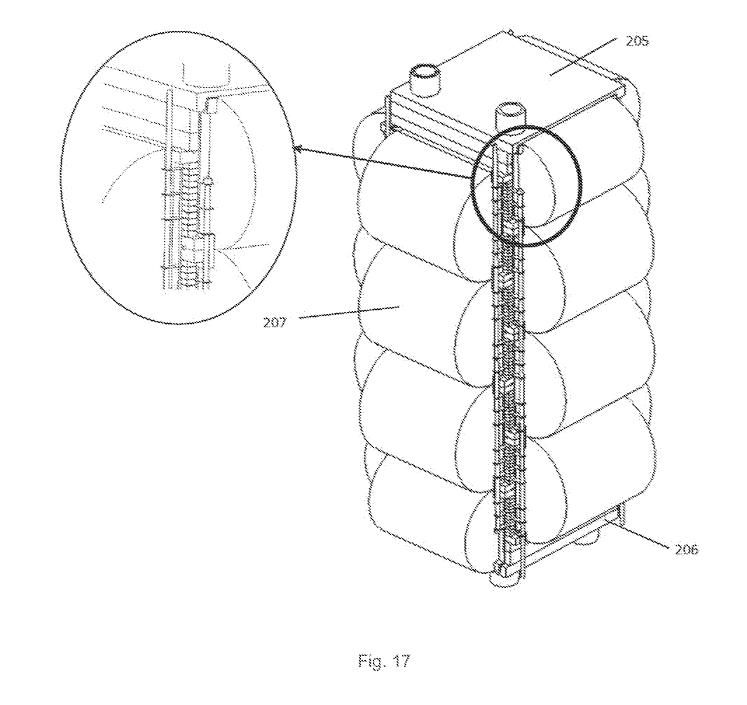

Referring to FIG. 17, it is a structural representation in which a feeding diversion chamber and a discharging diversion chamber are set on the upper part and the lower part of a battery stack and steering caps are set around the battery stack according to one embodiment of the invention.

Wherein, the positive electrode diversion chamber 253 and the negative electrode diversion chamber 254 of the feeding diversion chamber 205 and the discharging diversion chamber 206 are dendriform, which include a main channel and more than two subchannels branched from the main channel; the positive electrode liquid feed port 12 and the negative electrode liquid feed port 13 are respectively connected with the main channels of the positive electrode diversion chamber and the negative electrode diversion chamber of the feeding diversion chamber 205; the positive electrode liquid discharge port 14 and the negative electrode liquid discharge port 15 are respectively connected with the main channels of the positive electrode diversion chamber and the negative electrode diversion chamber of the discharging diversion chamber 206. In this embodiment, by the feeding diversion chamber and the discharging diversion chamber with a main channel and subchannels, the influence of a turbulence phenomenon caused by liquid feeding and discharging on the homogeneity of the battery can be reduced.

In the embodiment of the invention, steering caps 207 are set on the same lateral surface of the feeding diversion chamber and the first layer of battery module, adjacent two layers of battery modules, and the n^{th} layer of battery module and discharging diversion chamber. Referring to FIG. 15 and FIG. 17, seven battery modules are stacked together to form a battery stack, and steering caps 207 are set respectively on the side A, the side A′, the side B and the side B′ of the feeding diversion chamber and the first layer of battery module, the second and the third layers of battery modules, the fourth and the fifth layers of battery modules and the sixth and the seventh layers of battery module. The positive electrode pole 214 connected to the positive electrode tab 212 and the negative electrode pole 215 connected to the negative electrode tab 213 are located outside the steering cap.

If n is an even number, n/2+1 steering caps 207 are set on the side A of the feeding diversion chamber and the first layer of battery module, the second and the third layers of battery modules, . . . , the (n−2)^{th} and the (n−1)^{th} layers of battery modules, and the n^{th} layer of battery module and the discharging diversion chamber, and n/2 steering caps 207 are set on the side A′ of the first and the second layers of battery modules, . . . , and the (n−1)^{th} and the n^{th} layers of battery modules; moreover, n/2+1 steering caps 207 are set on the side B of the feeding diversion chamber and the first layer of battery module, the second and the third layers of battery modules, . . . , the (n−2)^{th} and the (n−1)^{th} layers of battery modules, and the n^{th} layer of battery module and the discharging diversion chamber, and n/2 steering caps 207 are set on the side B′ of the first and the second layers of battery modules, . . . , and the (n−1)^{th} and the n^{th} layers of battery modules.

If n is an odd number, (n+1)/2 steering caps 207 are respectively set on the side A of the feeding diversion chamber and the first layer of battery module, the second and the third layers of battery modules, . . . , and the (n−1)^{th} and the n^{th} layers of battery modules, and (n+1)/2 steering caps 207 are set on the side A′ of the first and the second layers of battery modules, . . . , the (n−2)^{th} and the (n−1)^{th} layers of battery modules, and the n^{th} layer of battery module and the discharging diversion chamber; moreover, (n+1)/2 steering caps 207 are respectively set on the side B of the feeding diversion chamber and the first layer of battery module, the second and the third layers of battery modules, . . . , and the (n−1)^{th} and the n^{th} layers of battery modules, and (n+1)/2 steering caps 207 are set on the side B′ of the first and the second layers of battery modules, . . . , the (n−2)^{th} and the (n−1)^{th} layers of battery modules, and the n^{th} layer of battery module and the discharging diversion chamber, wherein n is a natural number and n≧2.

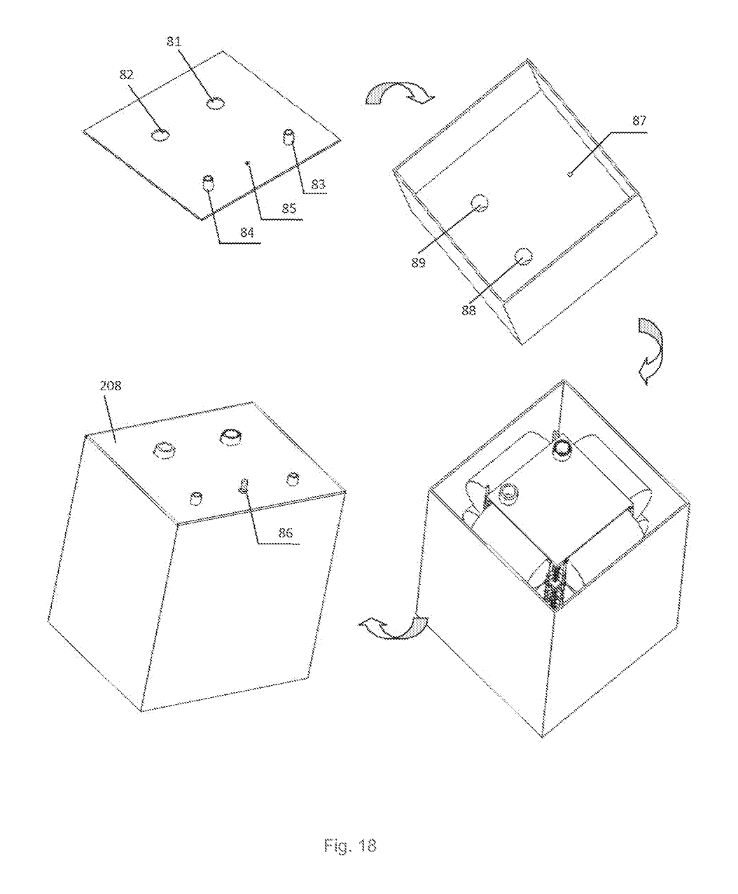

Referring to FIG. 18, it is a structural representation of a gas protection chamber according to one embodiment of the invention.

Wherein, a feeding diversion chamber 205, a battery stack, a steering cap 207 and a discharging diversion chamber 206 are placed inside a gas protection chamber 208, and a gas inlet 83, a gas outlet 84, an positive electrode pole hole 85, an positive electrode liquid inlet 81 and a negative electrode liquid inlet 82 are opened on the top of the gas protection chamber 208, wherein the positive electrode liquid inlet 81 and the negative electrode liquid inlet 82 are respectively connected with the positive electrode liquid feed port 12 and the negative electrode liquid feed port 13, and all the positive electrode poles 214 are connected by a wire and led out from the positive electrode pole hole to form an positive electrode main pole 86; a negative electrode pole hole 87, an positive electrode liquid outlet 88 and a negative electrode liquid outlet 89 are opened on the bottom, wherein the positive electrode liquid outlet 88 and the negative electrode liquid outlet 89 are respectively connected with the positive electrode liquid discharge port 14 and the negative electrode liquid discharge port 15, and all the negative electrode poles 215 are connected by another wire and led out from the negative electrode pole hole to form a negative electrode main pole. During the operation of the battery, the gas protection chamber is a closed box, and each part may be connected in a binding, welding or riveting mode.

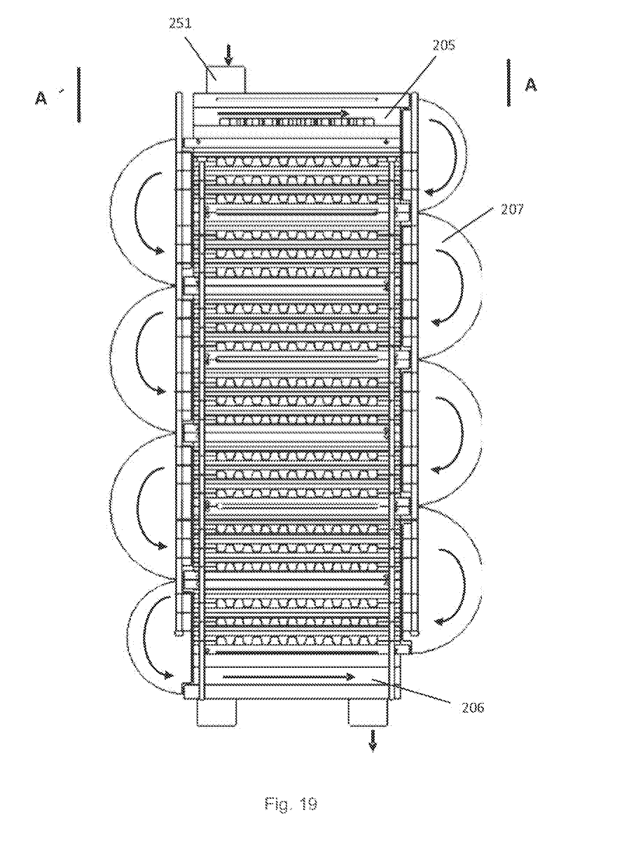

Referring to FIG. 19, it is a operation principle diagram of a pump-free lithium ion flow battery reactor according to one embodiment of the invention.

Wherein, an positive electrode suspension solution enters an positive electrode diversion chamber 253 of the feeding diversion chamber from an positive electrode liquid inlet 81 on the top of a gas protection chamber 208, and uniformly enters the steering cap on the side A and the positive electrode reacting chamber of the first layer of battery module under the diversion action of the channel, and then enters the steering cap on the side A′ and the positive electrode reacting chamber of the second layer of battery module, wherein the positive electrode suspension solution flows continuously in the steering cap and the positive electrode reacting chamber of each layer of battery module to form a S-shaped flow field, and enters the positive electrode diversion chamber in the discharging diversion chamber 206 after reaction, and then returns to positive electrode suspension solution pool from the positive electrode liquid discharge port. At the same time, the negative electrode suspension solution enters the negative electrode diversion chamber 254 of the feeding diversion chamber 205 from the negative electrode liquid inlet 82 on the top of the gas protection chamber, and then enters the negative electrode reacting chamber of the battery stack under the diversion action of the steering cap for reaction, and enters the discharging diversion chamber 206 after reaction and then returns to a negative electrode suspension solution pool from the negative electrode liquid discharge port.

During operation, the positive electrode suspension solution circulates in the positive electrode reacting chamber along the groove direction, and the negative electrode suspension solution circulates in the negative electrode reacting chamber along the groove direction, and the groove direction of the positive electrode current collecting plate and the groove direction of the negative electrode current collecting plate are perpendicular to each other. During charging and discharging, the lithium ions in the positive electrode suspension solution of the positive electrode reacting chamber and the lithium ions in the negative electrode suspension solution of the adjacent negative electrode reacting chamber may exchange via the electrolyte in the micropores of the porous separater 203 and the electrolyte between two porous separaters. The specific process is as follows: when the battery discharges, the lithium ions inside the negative electrode composite particles in the negative electrode reacting chamber are deintercalated and enter the electrolyte, reach the positive electrode reacting chamber through the porous separater, and are embedded inside the positive electrode composite particles; at the same time, the electrons inside the negative electrode composite particles in the negative electrode reacting chamber flow into the negative electrode current collecting plate 202, and flow into the negative electrode pole 215 through the negative electrode tab 213, and flow into the positive electrode pole 214 after working in the external circuit of the battery, and flow into the positive electrode current collecting plate 201 through the positive electrode tab 212, and finally are embedded inside the positive electrode composite particles in the positive electrode reacting chamber. The charging process of the battery is a reverse process. During the above discharging and charging process, the positive electrode composite particles in the positive electrode reacting chamber are in a continuous flow state or in a intermittent flow state, and a reticular electron-conducting channel is formed via the contact between the particles and the contact between the particles and the surface of the positive electrode current collecting plate 201; and it is similar for the negative electrode composite particles in the negative electrode reacting chamber. Thus, the charging and discharging process of the battery is carried out in the lithium ion flow battery reactor.

During the operation of the battery reactor, an inert gas enters the battery reactor from a gas inlet 83 on the top of the gas protection chamber, thus the whole battery reaction will be carried out in an inert gas protection atmosphere; at the same time, the inert gas enters the battery module from the gas channel 241 of the cooling plate 204, thus it can not only block the contact of external air and aqueous vapor with the electrode suspension solution, but also have a good heat dissipation action on the battery reactor. When the gas pressure reaches 0.1-0.2 Mpa, the inert gas is discharged from the gas outlet 84 on the top of the gas protection chamber. The inert gas is nitrogen gas or argon gas or a mixture of nitrogen gas and argon gas.

In the pump-free lithium ion flow battery according to the embodiment of the invention, a corrugated plate is employed as the current collecting plate of the reactor, thus the electrode suspension solution can uniformly flow into each chamber, the flowability of the electrode suspension solution can be improved, and at the same time, the current collecting area can be enlarged, and the magnification feature of the battery can be improved effectively; at the same time, in the embodiments of the invention, a steering cap is set on the lateral surface of adjacent two layers of battery modules, so that the electrode suspension solution can flow through each layer of battery module in turn, and an S-shaped flow field is formed, the flow rate of the electrode suspension solution is increased, and the effective volume for battery reaction is increased, thus the energy density of the battery may be improved greatly, and at the same time, the electrode suspension solution in each layer of battery module can flow uniformly. Additionally, in the embodiments of the invention, gas channels on the gas protection chamber and the cooling plate are employed, so that the inert protection gas can enter the battery reactor, thus the air tightness and the thermal diffusivity of the whole battery reactor may be guaranteed, and at the same time, the aqueous vapor and oxygen gas in the air, which may influence the utilization of the battery, can be isolated from the electrode suspension solution. Finally, by the feeding diversion chamber and the discharging diversion chamber with a main channel and subchannels according to the embodiments of the invention, the influence of a turbulence phenomenon caused by liquid feeding and discharging on the homogeneity of the battery can be reduced.

One embodiment of the invention further provides a preparation method of an electrode suspension solution for a pump-free lithium ion flow battery, which includes:

Step 101: Feeding in an electrode suspension solution.

Specifically, for an positive electrode suspension solution, first of all, the positive electrode liquid feed valve 17 is closed, and the positive electrode liquid distribution valve 28 is opened, the gas pressure in the positive electrode liquid preparation tank 27 and the positive electrode liquid discharge tank 20 is stabilized at a constant value in the range of 1˜2 atmospheric pressures via a pressure stabilizer and a pressure limiter, and the values of the gas pressure in the two tanks are the same; next, an positive electrode transportation tank 31 loaded with an positive electrode suspension solution is lifted to above the positive electrode liquid preparation tank 27, and the gas pressure in the positive electrode transportation tank 31 is adjusted via a pressure stabilizer and a pressure limiter to make the gas pressure in the positive electrode transportation tank 31 higher than the gas pressure in the positive electrode liquid preparation tank 27 by 0˜0.5 atmospheric pressure and keep it constant; then, the positive electrode transportation tank 31 is connected with the positive electrode liquid preparation tank 27 via a sealed tube, and the positive electrode suspension solution in the positive electrode transportation tank 31 flows into the positive electrode liquid preparation tank 27 and the positive electrode liquid feed tank 16 in turn under the action of gas pressure and gravity; and finally, when the content of the positive electrode suspension solution in the positive electrode liquid feed tank 16 reaches the capacity upper limit of the tank, the positive electrode liquid distribution valve 28 is closed, and when the content of the positive electrode suspension solution in the positive electrode liquid preparation tank 27 reaches the capacity upper limit of the tank, the connection between the positive electrode transportation tank 31 and the positive electrode liquid preparation tank 27 is disconnected, and system feeding is accomplished. For an negative electrode suspension solution, the feeding method thereof is consistent with that of the above positive electrode suspension solution, and the values of the gas pressure in the positive electrode liquid feed tank 16 and the negative electrode liquid feed tank 21 are the same and are kept constant.

Step 102: The electrode suspension solution entering the battery reactor 18 and participating in the battery reaction.

The gas pressure in the positive electrode liquid discharge tank 20 and the gas pressure in the negative electrode liquid discharge tank 24 are adjusted via a pressure stabilizer and a pressure limiter to make the gas pressure in the positive electrode liquid discharge tank 20 the same as the value of the gas pressure in the negative electrode liquid discharge tank 24 and lower than the gas pressure in the positive electrode liquid feed tank 16 and the negative electrode liquid feed tank 21 by 0˜0.5 atmospheric pressure and keep it constant; at the same time, the positive electrode liquid feed valve 17, the negative electrode liquid feed valve 22, the positive electrode liquid discharge valve 19 and the negative electrode liquid discharge valve 23 are opened. The positive electrode suspension solution and the negative electrode suspension solution flow into the positive electrode reacting chamber 1 and the negative electrode reacting chamber 2 respectively under the action of gravity and gas pressure, and flow into the positive electrode liquid discharge tank 20 and the negative electrode liquid discharge tank 24 respectively after participating in the battery reaction, and during this process, it is guaranteed that the positive electrode suspension solution and the negative electrode suspension solution enter the battery reactor 18 simultaneously.

Step 103: Collecting the electrode suspension solution after reaction.

When the content of the positive electrode suspension solution in the positive electrode liquid discharge tank 20 reaches the capacity upper limit, the suspension solution needs to be collected in the positive electrode liquid collection tank 30, and the gas pressure in the positive electrode liquid collection tank 30 is adjusted via a pressure stabilizer and a pressure limiter to make the gas pressure in the positive electrode liquid collection tank 30 lower than the gas pressure in the positive electrode liquid discharge tank 20 by 0˜0.5 atmospheric pressure and keep it constant, and the positive electrode liquid discharge valve 19 is opened, and the positive electrode suspension solution in the positive electrode liquid discharge tank 20 flows into the positive electrode liquid collection tank 30 under the action of gravity and gas pressure, and when the content of the positive electrode suspension solution in the positive electrode liquid discharge tank 20 reaches the capacity lower limit of the tank or when the content of the positive electrode suspension solution in the positive electrode liquid collection tank 30 reaches the capacity upper limit of the tank, the gas pressure in the positive electrode liquid collection tank 30 is adjusted to be consistent with the gas pressure in the positive electrode liquid discharge tank 20 via a pressure stabilizer and a pressure limiter, and the positive electrode liquid collecting valve is closed 29, thus the collecting of the positive electrode suspension solution is accomplished. For the negative electrode suspension solution, the collection control step is consistent with that of the above positive electrode suspension solution.

Step 104: Controlling the liquid preparation of the electrode suspension solution.

When the content of the positive electrode suspension solution in the positive electrode liquid feed tank 16 reaches the capacity lower limit, it needs to perform liquid preparation on the positive electrode liquid feed tank 16, and the specific method is as follows: the gas pressure in the positive electrode liquid preparation tank 27 is adjusted via a pressure stabilizer and a pressure limiter to make the gas pressure in the positive electrode liquid preparation tank 27 higher than the gas pressure in the positive electrode liquid feed tank 16 by 0˜0.5 atmospheric pressure and keep it constant. The positive electrode liquid distribution valve 28 is opened, and the positive electrode suspension solution in the positive electrode liquid preparation tank 27 flows into the positive electrode liquid feed tank 16 under the action of gravity and gas pressure, and when the volume of the positive electrode suspension solution in the positive electrode liquid feed tank 16 reaches the capacity upper limit of the tank or when the volume of the positive electrode suspension solution in the positive electrode liquid preparation tank 27 reaches the capacity lower limit of the tank, the gas pressure in the positive electrode liquid preparation tank 27 is adjusted to be consistent with the gas pressure in the positive electrode liquid feed tank 16 via a pressure stabilizer and a pressure limiter, and the positive electrode liquid distribution valve 28 is closed, thus liquid preparation is accomplished. For the negative electrode suspension solution, the preparation control step is consistent with that of the above positive electrode suspension solution.

Step 105: Controlling the transferring and transporting of the electrode suspension solution.

When the content of the positive electrode suspension solution in the positive electrode liquid collection tank 30 reaches the capacity upper limit or when the content of the positive electrode suspension solution in the positive electrode liquid preparation tank 27 reaches the capacity lower limit, it needs to transfer and transport the positive electrode suspension solution, and the specific method is as follows: when the content of the positive electrode suspension solution in the positive electrode liquid collection tank 30 reaches the capacity upper limit, the positive electrode transportation tank 31 is lowered to below the positive electrode liquid collection tank 30 via a mechanical lifting device, and the gas pressure in the positive electrode transportation tank 31 is adjusted via a pressure stabilizer and a pressure limiter to make the gas pressure in the positive electrode transportation tank 31 lower than the gas pressure in the positive electrode liquid collection tank 30 by 0˜0.5 atmospheric pressure and keep it constant. The positive electrode transportation tank 31 and the positive electrode liquid collection tank 30 are connected via a sealed tube, and the positive electrode suspension solution in the positive electrode liquid collection tank 30 flows into the positive electrode transportation tank 31 under the action of gravity and gas pressure, and when the positive electrode suspension solution in the positive electrode liquid collection tank 30 reaches the capacity lower limit or when the volume of the positive electrode suspension solution in the positive electrode transportation tank 31 reaches the capacity upper limit, the positive electrode transportation tank 31 and the positive electrode liquid collection tank 30 are disconnected; when the content of the positive electrode suspension solution in the positive electrode liquid preparation tank 27 reaches the capacity lower limit, the positive electrode transportation tank 31 is lifted to above the positive electrode liquid preparation tank 27 via a mechanical lifting device, and the gas pressure in the positive electrode transportation tank 31 is adjusted via a pressure stabilizer and a pressure limiter to make the gas pressure in the positive electrode transportation tank 31 higher than the gas pressure in the positive electrode liquid preparation tank 27 by 0˜0.5 atmospheric pressure and keep it constant, and the positive electrode transportation tank 31 and the positive electrode liquid preparation tank 27 are connected via a sealed tube, and the positive electrode suspension solution in the positive electrode transportation tank 31 flows into the positive electrode liquid preparation tank 27 under the action of gravity and gas pressure, and after the positive electrode suspension solution in the positive electrode transportation tank 31 completely flows into the positive electrode liquid preparation tank 27 or when the volume of the positive electrode suspension solution in the positive electrode liquid preparation tank 27 reaches the capacity upper limit, the positive electrode transportation tank 31 and the positive electrode liquid preparation tank 27 are disconnected. For the negative electrode suspension solution, the transferring and transporting control step is consistent with that of the above positive electrode suspension solution.

It may be seen from the above embodiments that, in the pump-free lithium ion flow battery according to the embodiments of the invention, the electrode suspension solution is circulated via gravity and gas pressure, thus the operation is simple, and it is convenient for control; especially, the use of a liquid pump may be avoided, thereby the mechanical loss in the battery circulation system may be reduced, and hidden safety risk of the fluid flow battery may be lowered, and at the same time, the battery efficiency and the safety performance may be improved; in the preparation method of an electrode suspension solution according to the embodiments of the invention, an insulative valve is used skillfully, and by controlling the insulative valve, the probability of short circuit in the prior art caused by the electron conductivity in the electrode suspension solution when battery reactors are connected in series may be eliminated, thus the problem that it is difficult to connect lithium ion fluid flow batteries in series may be solved. In addition, one embodiment of the invention further provides a battery reactor for a pump-free lithium ion flow battery, wherein a corrugated plate is employed as a current collecting plate, thus the electrode suspension solution can uniformly flow into each chamber, and the flowability of the electrode suspension solution can be improved, and at the same time, the current collecting area can be enlarged, thus the magnification feature of the battery can be improved effectively; because a steering cap is set on the lateral surfaces of adjacent two layers of battery modules, the electrode suspension solution can flow through each layer of battery module in turn, and an S-shaped flow field is formed, and the flow rate of the electrode suspension solution is increased, and the effective volume for battery reaction is increased, thus the energy density of the battery may be improved greatly, and at the same time, the electrode suspension solution in each layer of battery module can be made to flow uniformly; an inert protection gas can enter the battery reactor via a gas channel of the gas protection chamber and the cooling plate, thus the air tightness and the thermal diffusivity of the whole battery reactor may be guaranteed, and at the same time, the aqueous vapor and oxygen gas in the air, which may influence the utilization of the battery, can be isolated from the electrode suspension solution; moreover, due to the feeding diversion chamber and the discharging diversion chamber with a main channel and a subchannel, the influence of a turbulence phenomenon caused by liquid feeding and discharging on the homogeneity of the battery can be reduced.

Each embodiment in the specification is described in a stepped mode, reference may be made to each other for the same or similar part of each embodiment, and each embodiment emphasizes a difference from other embodiments. Especially, for system embodiments, because they are basically similar to the method embodiments, the description thereof is simple, and reference may be made to the illustration of the method embodiments for the related parts.

The above embodiments of the invention will not be construed as limiting the scope of the invention. All the modifications, equivalent substitutions and improvements made without departing from the spirit and principle of the invention should fall into the protection scope of the invention.

What is claimed is:

1. A pump-free lithium ion flow battery, characterized in that, the battery comprises: an positive electrode liquid preparation tank, a negative electrode liquid preparation tank, an positive electrode liquid collection tank, a negative electrode liquid collection tank, an positive electrode transportation tank, a negative electrode transportation tank and several battery subsystems;
the positive electrode liquid preparation tank and the negative electrode liquid preparation tank are located above said several battery subsystems, a liquid discharge port of the positive electrode liquid preparation tank is connected with an positive electrode liquid feed port of the battery subsystem via a tube, and an positive electrode liquid distribution valve is set on the tube; the liquid discharge port of the negative electrode liquid preparation tank is connected with the negative electrode liquid feed port of the battery subsystem via a tube, and a negative electrode liquid distribution valve is set on the tube, the positive electrode liquid collection tank and the negative electrode liquid collection tank are located below said several battery subsystems, and a liquid feed port of the positive electrode liquid collection tank is connected with an positive electrode liquid discharge port of the battery subsystem via a tube, and an positive electrode liquid collecting valve is set on the tube; a liquid feed port of the negative electrode liquid collection tank and a negative electrode liquid discharge port of the battery subsystem are connected via a tube, and a negative electrode liquid collecting valve is set on the tube.

2. The pump-free lithium ion flow battery according to claim 1, characterized in that, the circuit combination mode between said several battery subsystems is a series connection mode, and the battery subsystem comprises: an positive electrode liquid feed tank, a negative electrode liquid feed tank, an positive electrode liquid discharge tank, a negative electrode liquid discharge tank and an positive electrode liquid feed port, an positive electrode liquid discharge port, a negative electrode liquid feed port, a negative electrode liquid discharge port and several battery reactors;
the battery reactor comprises an positive electrode reacting chamber and a negative electrode reacting chamber, and the positive electrode liquid feed tank and the negative electrode liquid feed tank are located above the battery reactor; the liquid feed port of the positive electrode liquid feed tank is the positive electrode liquid feed port of the battery subsystem, the liquid discharge port of the positive electrode liquid feed tank is connected with the positive electrode reacting chamber of the battery reactor via a tube, and an positive electrode liquid feed valve is set therebetween; the liquid feed port of the negative electrode liquid feed tank is the negative electrode liquid feed port of the battery subsystem, the liquid discharge port of the negative electrode liquid feed tank is connected with the negative electrode reacting chamber of the battery reactor via a tube, and a negative electrode liquid feed valve is set therebetween, and the positive electrode liquid discharge tank and the negative electrode liquid discharge tank are located below the battery reactor; the liquid feed port of the positive electrode liquid discharge tank is connected with the positive electrode reacting chamber of the battery reactor via a tube, and an positive electrode liquid discharge valve is set therebetween, and the liquid discharge port of the positive electrode liquid discharge tank is the positive electrode liquid discharge port of the battery subsystem; the liquid feed port of the negative electrode liquid discharge tank is connected with the negative electrode reacting chamber of the battery reactor via a tube, and a negative electrode liquid discharge valve is set therebetween, and the liquid discharge port of the negative electrode liquid discharge tank is the negative electrode liquid discharge port of the battery subsystem;
during the operation of the lithium ion flow battery, at most one of the battery subsystems is in communication with the positive electrode liquid preparation tank, the positive electrode liquid collection tank, the negative electrode liquid preparation tank or the negative electrode liquid collection tank.

3. The pump-free lithium ion flow battery according to claim 2, characterized in that, the circuit combination mode between the battery reactors inside the battery subsystem is parallel connection mode;
the parallel arrangement mode of the battery reactors comprises: transversal arrangement from left to right, or longitudinal arrangement from top to bottom, or an array consisted of a plurality of transversal arrangements and a plurality of longitudinal arrangements.

4. The pump-free lithium ion flow battery according to claim 2 or 3, characterized in that, the positive electrode liquid preparation tank, the negative electrode liquid preparation tank, the positive electrode liquid collection tank, the negative electrode liquid collection tank, the positive electrode transportation tank and the negative electrode transportation tank, and the positive electrode liquid feed tank, the negative electrode liquid feed tank, the positive electrode liquid discharge tank and the negative electrode liquid discharge tank all comprise one or more liquid feed ports located on the bottom surface of the tank of the pump-free lithium ion flow battery and one or more liquid discharge ports located on the lateral surface of the tank, and an inert gas intake and an inert gas outlet are set on the top of the tank, and the inlet is connected with a gas storage system, and the outlet is connected with a gas collection system; a pressure stabilizer is set at the inlet, a pressure limiter is set at the outlet, and the pressure stabilizer and the pressure limiter adjust the gas pressure in the tank and keep it constant, and the inert gas recycled by the gas collection system enters the gas storage system for cyclic utilization after purification and pressurization.

5. The pump-free lithium ion flow battery according to claim 4, characterized in that, an positive electrode suspension solution and an inert gas are loaded in the positive electrode liquid feed tank and the positive electrode liquid discharge tank, and a negative electrode suspension solution and an inert gas are loaded in the negative electrode liquid feed tank and the negative electrode liquid discharge tank;
a soft gas bag is set fixedly on the top inside of the tank, and the soft gas bag is connected with the inlet and the outlet, and the soft gas bag is configured for pressurizing the positive electrode suspension solution or the negative electrode suspension solution by controlling the inert gas filled in so as to discharge the positive electrode suspension solution or the negative electrode suspension solution from the liquid discharge port.

6. The pump-free lithium ion flow battery according to any one claims 2 to 5, characterized in that, during the operation of the pump-free lithium ion flow battery, the gas pressure in the positive electrode liquid feed tank is kept consistent with the gas pressure in the negative electrode liquid feed tank, and the gas pressure in the positive electrode liquid discharge tank is kept consistent with the gas pressure in the negative electrode liquid discharge tank.

7. The pump-free lithium ion flow battery according to any one of claims 2 to 6, characterized in that, one or more positive electrode liquid preparation transition tanks are added between the positive electrode liquid preparation tank and the positive electrode liquid feed tank; one or more negative electrode liquid preparation transition tanks are added between the negative electrode liquid preparation tank and the negative electrode liquid feed tank; one or more positive electrode liquid collection transition tanks are added between the positive electrode liquid discharge tank and the positive electrode liquid collection tank; and one or more negative electrode liquid collection transition tanks are added between the negative electrode liquid discharge tank and the negative electrode liquid collection tank.

8. The pump-free lithium ion flow battery according to any one of claims 2 to 7, characterized in that, the fluid flow battery further comprises a safeguard system, which comprises: a battery monitoring subsystem and a suspension solution displacing device;
the battery monitoring subsystem is configured for monitoring each index of the pump-free lithium ion flow battery and starting the suspension solution displacing device when abnormality occurs on the pump-free lithium ion flow battery; and
the suspension solution displacing device is configured for separating the positive electrode suspension solution and the negative electrode suspension solution during starting.

9. The pump-free lithium ion flow battery according to claim 8, characterized in that, the battery monitoring subsystem comprises: a signal collection device, a microprocessor, a display instrument and an alarming and prompting device; wherein, the signal collection device, the display instrument and the alarming and prompting device are respectively connected with the microprocessor, and the signal collection device comprises a current sensor, a voltage sensor, a temperature sensor and a gas composition analysis sensor;
the current sensor and the voltage sensor are connected with the positive electrode and the negative electrode of the battery reactor, for respectively testing the current and voltage during the charging and discharging of the battery reactor;
the temperature sensor and the gas composition analysis sensor are set in an inert gas channel of the battery reactor, for respectively monitoring the real-time temperature and gas composition change of the battery reactor;
the microprocessor is configured for analyzing the current, voltage, temperature and gas composition collected by the signal collection system and starting the suspension solution displacing device when the analysis result is abnormal;
the alarming and prompting device is configured for alarming when the analysis result is abnormal; and
the data display instrument is configured for displaying the analysis result.

10. The pump-free lithium ion flow battery according to claim 8 or 9, characterized in that, the suspension solution displacing device comprises: an inert gas pressure control unit, a sealed tube, a suspension solution control valve and a gas pressure control valve, wherein the inert gas pressure control unit is respectively connected with the positive electrode reacting chamber and the negative electrode reacting chamber of the battery reactor via a sealed tube and a control valve;
when the suspension solution displacing device is started, by controlling the opening and closing of the suspension solution control valve and the gas pressure control valve, the positive electrode suspension solution is made to flow into an positive electrode suspension solution recycle tank, and the negative electrode suspension solution is made to flow into a negative electrode suspension solution recycle tank.

11. The pump-free lithium ion flow battery according to claim 8 or 9, characterized in that, the suspension solution displacing device comprises: an positive electrode inert liquid storage tank, an positive electrode inert liquid recycle tank, a negative electrode inert liquid storage tank, a negative electrode inert liquid recycle tank, an inert gas pressure control unit, a sealed tube and several control valves; wherein the positive electrode inert liquid storage tank, the positive electrode inert liquid recycle tank, the negative electrode inert liquid storage tank, the negative electrode inert liquid recycle tank, the inert gas pressure control unit, the sealed tube and the several control valves are respectively connected with the positive electrode reacting chamber and the negative electrode reacting chamber of the battery reactor;
when the suspension solution displacing device is started, by controlling the opening and closing of the suspension solution control valve and the gas pressure control valve, the positive electrode inert liquid is fed into the positive electrode reacting chamber of the battery reactor and mixed with the positive electrode suspension solution and then flows into the positive electrode inert liquid recycle tank, and the negative electrode inert liquid is fed into the negative electrode reacting chamber of the battery reactor and mixed with the negative electrode suspension solution and then flows into the negative electrode inert liquid recycle tank.

12. The pump-free lithium ion flow battery according to any one of claims 1 to 11, characterized in that, the valve body is an internal insulation valve, and when the internal insulation valve is opened, the electrode suspension solutions on the two sides of the valve body will be in communication with each other; when the internal insulation valve is closed, the electrode suspension solutions on the two sides of the valve body will be disconnected.

13. A pump-free lithium ion flow battery reactor, characterized in that, the battery reactor is a battery reactor applied to the pump-free lithium ion flow battery according to any one of claims 1 to 12, and the battery reactor comprises: a porous separater, an positive electrode current collecting plate and a negative electrode current collecting plate; wherein the positive electrode current collecting plate, the porous separater and the negative electrode current collecting plate are stacked together to form a stacked structure;
wherein, the positive electrode current collecting plate and the negative electrode current collecting plate are corrugated plates with a through groove, and the direction of the through groove of the positive electrode current collecting plate and the direction of the through groove of the negative electrode current collecting plate are perpendicular to each other; an positive electrode current collecting plate is set between the two porous separaters to form an positive electrode reacting chamber, and a negative electrode current collecting plate is set between the two porous separaters to form a negative electrode reacting chamber; the porous separaters are bound and fixed to the positive electrode current collecting plate and the negative electrode current collecting plate along the groove direction on the two sides of the current collecting plates, and the adjacent positive electrode reacting chamber and negative electrode reacting chamber are bound and fixed around the edge; the positive electrode suspension solution circulates in the positive electrode reacting chamber along the groove direction, and the negative electrode suspension solution circulates in the negative electrode reacting chamber along the groove direction; the lateral surfaces on the two ends of the circulation direction of the positive electrode suspension solution are respectively side A and side A′, and the lateral surfaces on the two ends of the circulation direction of the negative electrode suspension solution are respectively side B and side B′, wherein, the side A and the side A′ are respectively perpendicular to the side B the side B′.

14. The battery reactor according to claim 13, characterized in that, the sectional waveforms of the positive electrode current collecting plate and the negative electrode current collecting plate comprise: sine wave, square wave, triangular wave, trapezoidal wave, sawtooth wave, impulse wave or convex-concaved abnormity wave.

15. The battery reactor according to claim 13 or 14, characterized in that, an aluminum plate or an aluminum-coated metal plate is employed as the material of the positive electrode current collecting plate, and the thickness is in the range of 0.05 to 0.5 mm; a copper plate, a nickel plate, a copper-coated metal plate or a nickel-coated metal plate is employed as the material of the negative electrode current collecting plate, and the thickness is in the range of 0.05 to 0.5 mm.

16. The battery reactor according to any one of claims 13 to 15, characterized in that, an insulating layer is coated on the outside of the convex points or the concave points of the positive electrode current collecting plate or the negative electrode current collecting plate; and the thickness of the insulating layer is less than 0.1 mm.

17. The battery reactor according to any one of claims 13 to 16, characterized in that, an positive electrode tab is respectively set on the side A and the side A′ of the positive electrode current collecting plate, and the positive electrode current collecting plate of each layer is respectively connected by an positive electrode pole via the positive electrode tab; a negative electrode tab is respectively set on the side B and the side B′ of the negative electrode current collecting plate, and the negative electrode current collecting plate of each layer is respectively connected by a negative electrode pole via the negative electrode tab; the positive electrode pole and the negative electrode pole are respectively conductive metal rods.

18. The battery reactor according to any one of claims 13 to 17, characterized in that, the battery reactor further comprises: two cooling plates, wherein a gas channel is set on the surface of the cooling plate, a structure stacked by the porous separater and the positive electrode current collecting plate and the negative electrode current collecting plate is located between the two cooling plates to form a battery module, and n battery modules are stacked together to form a battery stack, wherein n is a natural number greater than 1.

19. The battery reactor according to claim 18, characterized in that, a feeding diversion chamber and a discharging diversion chamber are respectively provided on the upper part and the lower part of the battery stack, and an positive electrode diversion chamber and a negative electrode diversion chamber that are not in communication with each other are provided respectively inside the feeding diversion chamber and the discharging diversion chamber, and the feeding diversion chamber is provided with an positive electrode liquid feed port and a negative electrode liquid feed port, and one end of the positive electrode diversion chamber and the negative electrode diversion chamber is respectively connected with the positive electrode liquid feed port and the negative electrode liquid feed port, and the other end respectively leads to two perpendicular lateral surfaces of the feeding diversion chamber, and the two lateral surfaces are the side A and the side B; and the discharging diversion chamber is provided with an positive electrode liquid discharge port and a negative electrode liquid discharge port, and one end of the positive electrode diversion chamber and the negative electrode diversion chamber is respectively connected with the positive electrode liquid discharge port and the negative electrode liquid discharge port, and the other end respectively leads to two perpendicular lateral surfaces of the discharging diversion chamber, and the two lateral surfaces are respectively the side A and the side B or the side A′ and the side B′.

20. The battery reactor according to claim 19, characterized in that, steering caps are set on the same lateral surface of the feeding diversion chamber and the first layer of the battery module, adjacent two layers of battery modules, and the n^{th} layer of battery module and the discharging diversion chamber;
if n is an even number, n/2+1 steering caps are set on the side A of the feeding diversion chamber and the first layer of the battery module, the second and the third layers of battery modules, the (n−2)^{th} and the (n−1)^{th} layers of battery modules, and the n^{th} layer of battery module and the discharging diversion chamber, and n/2 steering caps are set on the side A′ of the first and the second layers of battery modules and the (n−1)^{th} and the n^{th} layers of battery modules; moreover, n/2+1 steering caps are set on the side B of the feeding diversion chamber and the first layer of battery module, the second and the third layers of battery modules, the (n−2)^{th} and the (n−1)^{th} layers of battery modules, and the n^{th} layer of battery module and the discharging diversion chamber, and n/2 steering caps are set on the side B′ of the first and the second layers of battery modules, the second and the third layers of battery modules and the (n−1)^{th} and the n^{th} layers of battery modules;
if n is an odd number, (n+1)/2 steering caps are respectively set on the side A of the feeding diversion chamber and the first layer of battery module, the second and the third layers of battery modules, and the (n−1)^{th} and the n^{th} layers of battery modules, and (n+1)/2 steering caps are set on the side A′ of the first and the second layers of battery modules, the second and the third layers of battery modules, the (n−2)^{th} and the (n−1)^{th} layers of battery modules, and the n^{th} layer of battery module and the discharging diversion chamber; moreover, (n+1)/2 steering caps are respectively set on the side B of the feeding diversion chamber and the first layer of battery module, the second and the third layers of battery modules, the (n−1)^{th} and the n^{th} layers of battery modules, and (n+1)/2 steering caps are set on the side B′ of the first and the second layers of battery modules, the second and the third layers of battery modules, the (n−2)^{th} and the (n−1)^{th} layers of battery modules, and the n^{th} layer of battery module and the discharging diversion chamber.

21. The battery reactor according to claim 19 or 20, characterized in that, the positive electrode diversion chamber and the negative electrode diversion chamber of the feeding diversion chamber and the discharging diversion chamber are dendriform, which comprise a main channel and more than two subchannels branched from the main channel; the positive electrode liquid feed port and the negative electrode liquid feed port are respectively connected with the main channels of the positive electrode diversion chamber and the negative electrode diversion chamber of the feeding diversion chamber; the positive electrode liquid discharge port and the negative electrode liquid discharge port are respectively connected with the main channel of the positive electrode diversion chamber and the negative electrode diversion chamber of the discharging diversion chamber.

22. The battery reactor according to any one of claims 19 to 21, characterized in that, the battery reactor further comprises a gas protection chamber;
wherein, the feeding diversion chamber, the battery stack, the steering cap and the discharging diversion chamber are placed inside the gas protection chamber, and a gas inlet, a gas outlet, an positive electrode pole hole, an positive electrode liquid inlet and a negative electrode liquid inlet are opened on the top of the gas protection chamber, and the positive electrode liquid inlet and the negative electrode liquid inlet are respectively connected with the positive electrode liquid feed port and the negative electrode liquid feed port, and the positive electrode pole is connected by a wire and led out from the positive electrode pole hole to form an positive electrode main pole; a negative electrode pole hole, an positive electrode liquid outlet and a negative electrode liquid outlet are opened on the bottom of the gas protection chamber, and the positive electrode liquid outlet and the negative electrode liquid outlet are respectively connected with the positive electrode liquid discharge port and the negative electrode liquid discharge port, and all the negative electrode poles are connected with another wire and led out from the negative electrode pole hole to form a negative electrode main pole.

23. A preparation method of an electrode suspension solution for a pump-free lithium ion flow battery, characterized in that, the method is configured for preparing the electrode suspension solution in the pump-free lithium ion flow battery according to any one of claims 1 to 12, and the preparation method comprises:
feeding in an electrode suspension solution: when the electrode suspension solution is an positive electrode suspension solution, the positive electrode liquid feed valve is closed, and the positive electrode liquid distribution valve is opened, and the gas pressure in the positive electrode liquid preparation tank and the positive electrode liquid discharge tank is stabilized at a constant value in the range of 1 to 2 atmospheric pressures via a pressure stabilizer and a pressure limiter, and the value of the gas pressure in the positive electrode liquid preparation tank is made the same as that in the positive electrode liquid discharge tank; an positive electrode transportation tank loaded with an positive electrode suspension solution is lifted to above the positive electrode liquid preparation tank, and the gas pressure in the positive electrode transportation tank is adjusted via a pressure stabilizer and a pressure limiter to make the gas pressure in the positive electrode transportation tank higher than that in the positive electrode liquid preparation tank by 0 to 0.5 atmospheric pressure, and the gas pressure is kept constant; the positive electrode transportation tank and the positive electrode liquid preparation tank are connected via a sealed tube, so that the positive electrode suspension solution in the positive electrode transportation tank flows into the positive electrode liquid preparation tank and the positive electrode liquid feed tank in turn under the action of gas pressure and gravity; when the content of the positive electrode suspension solution in the positive electrode liquid feed tank reaches the capacity upper limit of the tank, the positive electrode liquid distribution valve is closed, and when the content of the positive electrode suspension solution in the positive electrode liquid preparation tank reaches the capacity upper limit of the tank, the connection between the positive electrode transportation tank and the positive electrode liquid preparation tank is disconnected, and system feeding is accomplished; when the electrode suspension solution is a negative electrode suspension solution, the feeding mode of the negative electrode suspension solution is consistent with that of the positive electrode suspension solution, and the value of the gas pressure in the positive electrode liquid feed tank is constant and the same as that in the negative electrode liquid feed tank;
the electrode suspension solution entering the battery reactor and participating in the battery reaction: the gas pressure in the positive electrode liquid discharge tank and the gas pressure in the negative electrode liquid discharge tank are adjusted via a pressure stabilizer and a pressure limiter to make the gas pressure in the positive electrode liquid discharge tank the same as the gas pressure in the negative electrode liquid discharge tank and lower than the gas pressure in the positive electrode liquid feed tank and the negative electrode liquid feed tank by 0 to 0.5 atmospheric pressure, and the gas pressure is kept constant; at the same time, the positive electrode liquid feed valve, the negative electrode liquid feed valve, the positive electrode liquid discharge valve and the negative electrode liquid discharge valve are opened to make the positive electrode suspension solution and the negative electrode suspension solution respectively flow into the positive electrode reacting chamber and the negative electrode reacting chamber under the action of gravity and gas pressure, and respectively flow into the positive electrode liquid discharge tank and the negative electrode liquid discharge tank after participating in the battery reaction, and during the flowing process, the positive electrode suspension solution and the negative electrode suspension solution are controlled to enter the battery reactor simultaneously;
collecting the electrode suspension solution after the battery reaction: during the collecting of the positive electrode suspension solution, when the content of the positive electrode suspension solution in the positive electrode liquid discharge tank reaches the capacity upper limit, the gas pressure in the positive electrode liquid collection tank is adjusted via a pressure stabilizer and a pressure limiter to make the gas pressure in the positive electrode liquid collection tank lower than the gas pressure in the positive electrode liquid discharge tank by 0 to 0.5 atmospheric pressure, and the gas pressure is kept constant; the positive electrode liquid discharge valve is opened to make the positive electrode suspension solution in the positive electrode liquid discharge tank flow into the positive electrode liquid collection tank under the action of gravity and gas pressure, and when the content of the positive electrode suspension solution in the positive electrode liquid discharge tank reaches the capacity lower limit of the tank, or when the content of the positive electrode suspension solution in the positive electrode liquid collection tank reaches the capacity upper limit of the tank, the gas pressure in the positive electrode liquid collection tank is adjusted to be consistent with the gas pressure in the positive electrode liquid discharge tank via a pressure stabilizer and a pressure limiter, and the positive electrode liquid collecting valve is closed; during the collecting of the negative electrode suspension solution, the collecting process of the negative electrode suspension solution is consistent with the collecting process of the positive electrode suspension solution.

24. The preparation method according to claim 23, characterized in that, the method further comprises preparing an positive electrode suspension solution into the positive electrode liquid feed tank when the content of the positive electrode suspension solution in the positive electrode liquid feed tank reaches the capacity lower limit; when the content of the negative electrode suspension solution in the negative electrode liquid feed tank reaches the capacity lower limit, a negative electrode suspension solution is prepared into the negative electrode liquid feed tank;
the preparation process of the positive electrode suspension solution comprises: adjusting the gas pressure in the positive electrode liquid preparation tank via a pressure stabilizer and a pressure limiter to make the gas pressure in the positive electrode liquid preparation tank higher than the gas pressure in the positive electrode liquid feed tank by 0 to 0.5 atmospheric pressure, and keeping the gas pressure constant; opening the positive electrode liquid distribution valve to make the positive electrode suspension solution in the positive electrode liquid preparation tank flow into the positive electrode liquid feed tank under the action of gravity and gas pressure, and when the volume of the positive electrode suspension solution in the positive electrode liquid feed tank reaches the capacity upper limit of the tank or when the volume of the positive electrode suspension solution in the positive electrode liquid preparation tank reaches the capacity lower limit of the tank, adjusting the gas pressure in the positive electrode liquid preparation tank to be consistent with the gas pressure in the positive electrode liquid feed tank via a pressure stabilizer and a pressure limiter, and closing the positive electrode liquid distribution valve; the preparation process of the negative electrode suspension solution is consistent with the preparation process of the positive electrode suspension solution.

25. The preparation method according to claim 23, characterized in that, the method further comprises:
transferring and transporting the positive electrode suspension solution when the content of the positive electrode suspension solution in the positive electrode liquid collection tank reaches the capacity upper limit or when the content of the positive electrode suspension solution in the positive electrode liquid preparation tank reaches the capacity lower limit; transferring and transporting the negative electrode suspension solution when the content of the negative electrode suspension solution in the negative electrode liquid collection tank reaches the capacity upper limit or when the content of the negative electrode suspension solution in the negative electrode liquid preparation tank reaches the capacity lower limit;
the transferring and transporting process of the positive electrode suspension solution comprises: lowering the positive electrode transportation tank to below the positive electrode liquid collection tank via a mechanical lifting device when the content of the positive electrode suspension solution in the positive electrode liquid collection tank reaches the capacity upper limit, and adjusting the gas pressure in the positive electrode transportation tank via a pressure stabilizer and a pressure limiter to make the gas pressure in the positive electrode transportation tank lower than the gas pressure in the positive electrode liquid collection tank by 0 to 0.5 atmospheric pressure and keeping the gas pressure constant; connecting the positive electrode transportation tank and the positive electrode liquid collection tank via a sealed tube to make the positive electrode suspension solution in the positive electrode liquid collection tank flow into the positive electrode transportation tank under the action of gravity and gas pressure, and disconnecting the positive electrode transportation tank and the positive electrode liquid collection tank until the positive electrode suspension solution in the positive electrode liquid collection tank reaches the capacity lower limit or until the volume of the positive electrode suspension solution in the positive electrode transportation tank reaches the capacity upper limit; lifting the positive electrode transportation tank to above the positive electrode liquid preparation tank via a mechanical lifting device when the content of the positive electrode suspension solution in the positive electrode liquid preparation tank reaches the capacity lower limit, and adjusting the gas pressure in the positive electrode transportation tank via a pressure stabilizer and a pressure limiter to make the gas pressure in the positive electrode transportation tank higher than the gas pressure in the positive electrode liquid preparation tank by 0 to 0.5 atmospheric pressure, and keeping the gas pressure constant, and connecting the positive electrode transportation tank and the positive electrode liquid preparation tank via a sealed tube to make the positive electrode suspension solution in the positive electrode transportation tank flow into the positive electrode liquid preparation tank under the action of gravity and gas pressure, and disconnecting the positive electrode transportation tank and the positive electrode liquid preparation tank when the positive electrode suspension solution in the positive electrode transportation tank completely flows into the positive electrode liquid preparation tank or when the volume of the positive electrode suspension solution of the positive electrode liquid preparation tank reaches the capacity upper limit; the transferring and transporting process of the negative electrode suspension solution is consistent with the transferring and transporting process of the positive electrode suspension solution.
